(19) United States
(12) Patent Application Publication
(10) Pub. No.: US 2014/0294968 A1
(43) Pub. Date: Oct. 2, 2014

(54) POLYACRYLATE-BASED ACTIVE COMPOUND-COMPRISING PARTICLES

(71) Applicants: Stefan Hofmann, Langenfeld (DE); Claudia Selbach, Wermelskirchen (DE); Eva Maria Krüdewagen, Monheim (DE); Dorothee Stanneck, Solingen (DE)

(72) Inventors: Stefan Hofmann, Langenfeld (DE); Claudia Selbach, Wermelskirchen (DE); Eva Maria Krüdewagen, Monheim (DE); Dorothee Stanneck, Solingen (DE)

(73) Assignee: BAYER INTELLECTUAL PROPERTY GMBH, Monheim (DE)

(21) Appl. No.: 14/235,126

(22) PCT Filed: Jul. 23, 2012
(86) PCT No.: PCT/EP2012/064424

§ 371 Date: May 28, 2014

(30) Foreign Application Priority Data
Jul. 27, 2011 (EP) 11175537.7

(51) Int. Cl. A01N 25/12; A01N 43/40; A01N 37/18; A01N 53/00

(52) U.S. Cl. CPC A01N 25/12; A01N 53/00; A01N 43/40; A01N 37/18
USPC 424/489; 514/521; 514/315; 514/617

(57) ABSTRACT

The invention relates to novel polyacrylate-based active compound-comprising particles which bind to hair, and to the use of these particles for preparing medicaments, in particular for veterinary medicine. The particles comprise uncharged and cationic polyacrylate and are at most 10 um big.

The invention relates to novel polyacrylate-based active compound-comprising particles which bind to hair, and to the use of these particles for preparing medicaments, in particular for veterinary medicine.

In the context of the present invention, the term active compound is to be understood hereinbelow as meaning both the classic pharmaceutical and insecticidally active compounds and any form of beneficial agent in animal husbandry.

The external application of active compounds is an administration form which is preferred in veterinary medicine and is used in particular for formulations of active compounds for protection against ectoparasites, but also of transdermally effective active compounds and active compounds which moderate the behaviour of the animals treated, or else that of interacting animals. For this purpose, use is frequently made of spot-on or wipe-on formulations, where the active compound is applied in liquid form or else as a spray into or onto the coat or the skin of the animals. In most cases, the duration of action of such formulations is limited to a few days or weeks, in the case of repellent active compounds in some cases to a few hours. In many cases, the active compounds, or components of the formulation, may also cause skin irritation or extensive local inflammation. Accordingly, it is advantageous to provide administration forms
which allow a longer duration of action to be achieved
which cause little, if any, skin irritation
which are easy to manufacture
and which have no adverse effect on the functional or haptic properties of animal coat or animal skin.

We have now found that it is possible to achieve this in cationic active compound-comprising microcapsules of a small size which are applied to the skin or the hair of the animal treated and which release the active compound in a controlled and delayed manner.

The delayed release of active compounds from uncharged and charged microparticles applied to hair or the skin is well known in the field of application of cosmetics or skin care products. In these fields of application, the microparticles themselves are also capable of influencing the properties of the hairs. However, a relatively long application in the range of days or weeks has not been described in these fields of application, and in addition, it is not the object of these applications.

In pharmaceutical applications, the encapsulation of active compounds in cationic microparticles is also known and described. Here, use is frequently made of quaternized dimethylaminoethyl methacrylate copolymers (for example polymers from Evonik Industries having the trade name “Eudragit® RS, RL”). However, these microparticles are mainly used for oral administration forms in pharmacy and having a size in the order of >30 μm to 1000 μm, are too big for application on animal hair. Moreover, the methods described for the preparation do not yield microparticles having a size of an order suitable for the application according to the invention. The use of quaternized dimethylaminoethyl methacrylate both in hair care products and in transdermal therapeutic systems is known. However, in these cases the polymers are not used in combination with microparticles.

Skin irritation by active compounds can be avoided in principle by applying the active compounds in spray form, dissolved in a solvent, to the coat of the animal. This application, too, is known to the person skilled in the art and described in the literature. However, in general this does not achieve any prolonged action.

Hereinbelow, the prior art is described in more detail using selected examples. However, none of the methods and technologies listed can achieve the advantage of the present invention
microparticles for the delayed release of active compounds, sufficiently small for adhering to hair,
prolonged adhesion to hair by covering the surface of the microparticles with cationic polymers,
no negative effect on the functional and haptic properties of the hair, and
simple manufacture via an emulsion process.

Water-insoluble cationic polymers of the quaternized dimethylaminoethyl methacrylate copolymer type are used as film-formers in coatings of tablets and granules to control and delay the decomposition of the tablets and the release of active compound in a pH-independent manner (Evonik Industries: Eudragit® Application Guidelines, 10th Edition, Darmstadt, Germany; Evonik Industries AG, 2008).

For the purpose of the present invention, quaternized dimethylaminoethyl methacrylate copolymers are preferably understood as meaning a group of water-insoluble polymers known under the trade name Eudragit® RS or Eudragit® RL from Evonik (as at 2011). These are copolymers of acrylic acid and methacrylic acid having a low proportion of quaternized ammonium groups. (Chemical names: poly(ethyl acrylate-co-methyl methacrylate-co-trimethylammonioethyl methacrylate chloride) having a copolymerization ratio of 1:2:0.1, CAS number: 33434-24-1, trade name Eudragit® RS, described in Ph. Eur. as ammonio methacylate copolymer, type B; and poly(ethyl acrylate-co-methyl methacrylate-co-trimethylammonioethyl methacrylate chloride) having a copolymerization ratio of 1:2:0.2, CAS number: 33434-24-1, trade name Eudragit® RL, described in Ph. Eur. as ammonio methacyrlate copolymer, type A). They can be employed as aqueous dispersion (Eudragit® RS, RL 30D) or as granules (Eudragit® RS, RL PO):

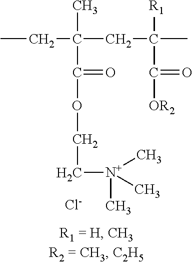

### General Structural Formula of Copolymers of the “Eudragit® RL, RS” Type

The manufacturer states the mean molecular weight of Eudragit® type RS, RL as a weight average value of M_{w}=30 000 g/mol (Eudragit® RS) and M_{w}=31 000 g/mol (Eudragit® RL); the glass transition temperature is stated as 65° C. (Eudragit® RS) and 70° C. (Eudragit® RL). (Evonik Industries: Eudragit Application Guidelines 10th Edition, Darmstadt, Germany: Evonik Industries AG, 2008).

It is known that cationic polymers adhere well to negatively charged interfaces such as hair and skin and are capable of forming films thereon. This principle is utilized for hair setting lotions and haircare products. Eudragit® is also used for this purpose. EP 1092417, for example, describes the use of cationic Eudragit® as a film-forming polymer which can be incorporated in finely dispersed form in shampoos and provides the hair with increased strength and improved hold. Additives mentioned are hair-cosmetic active compounds, such as vitamins, but no pharmaceutically active compounds. WO97/45012 describes the use of film-forming cationic polymers in formulations comprising ectoparasiticidally active compounds, specifically pyrethroids, which, by virtue of their affinity to hair, allow a longer-lasting attachment of the active compounds to the hair. Mention is made of cationic polymers of the polyquaternium type (Polyquat 10,28,11), cationic guar gum derivatives and also Eudragit RS. For one formulation, an ectoparasiticidal activity of 8 days is described. However, the cationic polymers mentioned in WO97/45012 are not capable of forming suitable microparticles for the purpose of the present invention. Accordingly, a duration of action of weeks, as can be achieved with the active compound-comprising microparticles of the present invention, is not demonstrated. Film-forming acrylate copolymers of the Eudragit® type are also used in dermal and transdermal therapeutic systems. JP 03-077820 illustrates the use of a liquid formulation of these polymers in a suitable solvent, preferably ethanol, which additionally comprises antibacterial or anti-inflammatory agents. Insect repellents as active compound are likewise mentioned. The formulations are applied to the skin as a liquid or as a spray. WO02/060417 claims the cationic methacrylate copolymers as adhesives or binders for transdermal therapeutic systems. The formulations comprise plasticizers and pharmaceutically active compounds. A further embodiment are dental applications on the oral mucosa or for the treatment of dental pockets. U.S. Pat. No. 5,438,076 and EP 0404558 described the use of Eudragit® L, RL or RS in alcoholic solution together with antibacterially active compounds and plasticizers. A longer lasting release of the active compounds from the films adhering to the mucosa is noticed. The reduced solubility of the polymer materials in water is another advantage, since removal by saliva is delayed, but biological degradation is still ensured. JP 63-130541 describes a similar process in which the Eudragit® together with antibacterially active compound and hydrophilic polymers (cellulose ether, PVP) is dissolved in polyhydric alcohols and the active compound is released longer from the films formed, compared to preparations without cationic polymer. In such systems, the term “long-lasting release/application” always refers to a period in the range from hours to a few days. The time periods required for the application according to the invention cannot be achieved in this manner.

In principle, microparticles adhering to hair or skin are capable of releasing the active compounds comprised therein over a relatively long period of time. However, the problem of achieving a relatively long adherence of the microparticles to the hairs has to be overcome. Since hairs have a negative surface charge, it is feasible to promote adherence by a) making the particles cationic or b) alternatively providing the hairs with cationic coatings to bind the negatively charged microparticles to hairs in this manner.

Procedure b) is shown in WO01/87243. This describes the use of PTFE microparticles in hair care products whose adherence to hairs was improved by adding cationic polymers to the preparation. The publication mentions cationized dialkylmethacrylamides. These PTFE particles improve hair properties. A similar process is utilized in WO97/38667. Microparticles consisting of polystyrene, PMMA and other polymers having a diameter of 0.2-1 μm are applied to hair. Cationization of the particles is carried out using cationic polymers or cationic surfactants which are either used as matrix polymer or mixed into the formulations as an additive. The particles serve to improve hair gloss. However, a long-lasting adherence for weeks is not achieved and not described. These systems likewise do not serve for the application of active compounds.

Alternatively, anionic microparticles may be coated with cationic polymers. U.S. Pat. No. 5,753,264 describes the preparation of preemulsions of an oil phase comprising the active compound (oils which act as a repellent to lice, vitamins) with anionic surfactants in aqueous solution and the subsequent formation of a polymer coat by coacervation with chitosan from an acidic aqueous solution by pH shift. Subsequent crosslinking leads to cationically charged, very fine microparticles <10 μm. These microparticles can be applied to human hair. In an in vitro test, a repelling action for one week is demonstrated. However, a longer duration of action of the encapsulated emulsions compared to the emulsions applied in unencapsulated form is not demonstrated. U.S. Pat. No. 0,142,828 shows that active compounds, preferably perfumes, but also insect repellents, can be introduced into microparticles of urea/melamine formaldehyde resins by forming an aqueous primary emulsion and subsequent polycondensation. Mentioned as an alternative are complex coacervates of gelatine or polyacrylate polymers. In a second step, these microparticles are then coated with the cationic polymer. Cationized starch, guar gum, polysiloxanes can be used for this purpose, but polyesters are also mentioned. These cationized capsules of a diameter of 2-15 μm can be applied to hair and release the contents. It is demonstrated that, compared to non-cationized capsules, substantially more active compound can be applied to the hair and released. FR 2801811 describes a similar process where the charge of microcapsules comprising negatively charged active compounds is changed by applying a cationic polymer (polyquaternium types), thus allowing the microcapsules to be applied to negatively charged textile fibres or hairs. However, these applications do not mention the use of quaternized dimethylaminoethyl methacrylate copolymers (Eudragit® RS, RL).

However, the processes mentioned require several process steps to generate the cationic microcapsules, and they are therefore unsuitable for a simple industrial preparation. Moreover, the cationic polymers used have to be water-soluble. Eudragit® RS/RL are water-insoluble and therefore unsuitable for the techniques described herein.

The aim of other process developments is to provide the microcapsules themselves during preparation with a cationic surface charge. WO01/35933 describes the production of microcapsules where the material to be encapsulated (for example vitamins) together with the coating polymer is dissolved in an organic solvent which has to be partially soluble in water (in most cases ethyl acetate). The preferred coating polymer is PMMA. This solution is dispersed in an aqueous phase which comprises an emulsifier and has been saturated with the organic solvent. From the emulsion, the solvent is removed by solvent extraction, resulting in the formation of microparticles having a size of 3-300 μm. However, the microcapsules do not carry any charge. The application WO01/35933 therefore describes a process alternative where the coating polymer used is Eudragit® RS PO, which is applied to the primary particles in a second step. In this manner, the microparticles are provided with a cationic surface charge. An advantage which is emphasized is that the process does not require any chlorinated hydrocarbons as solvent. However, the process described has a substantial disadvantage in that the solvent extraction process requires a large excess of aqueous phase. Thus, the dispersions obtained comprise, for example, only 0.2% or 0.4% solid, requiring concentration or drying steps. In contrast, the preparation procedure described in the present invention allows a one-pot process. The proportion by volume of the polymer phase can be adjusted variably such that, after removal of the organic solvent, a dispersion is formed which can be filled into containers or applied directly, if appropriate after addition of further formulation components. The microcapsules of WO01/35933 can be applied according to the invention to skin or hair; however, having the size mentioned, they are unsuitable for long-lasting applications on hair. The examples of WO01/35933 describe particle sizes of a diameter of 40-100 μm. With hair having a diameter of 50-120 μm, depending on the hair type, it is obvious that such particles are too big and unsuitable for long-lasting adherence on animal hair. Moreover, the particles obtained are visible to the naked eye and thus change the visual appearance of the animal coat. In contrast, using the preparation process in accordance with the present invention, the suitable and preferred particle sizes in the range of 0.1-3 μm can be achieved easily. Furthermore, to form the preemulsion, an external emulsifier is required in the outer aqueous phase. The substances dissolved in the oil phase are not capable of self-emulsifying action.

EP 1407753 and EP 1407754 describe a process where copolymers of polyacrylamide and acrylic acid are dispersed together with melamine-formaldehyde resins in aqueous solution. Perfume oils are introduced into this solution. An increase in temperature initiates polycondensation around the oil droplets. By addition of cationic polymer during the reaction phase, this is incorporated into the outer layer of the microparticles. Explicitly mentioned is the necessity of the chemical compatibility of the polycondensate with the material of the capsule wall. These cationic microparticles can then be applied to textiles or incorporated into shampoos for use on hair and skin. In a general manner, polyesters are mentioned as examples of cationic polymer groups. However, Eudragit® types are not described. WO02060399 states that cationic hair care products or cationic polymers, for example polyethyleneimine, are melted together with active compounds and a hydrophobic matrix polymer. This melt is emulsified in a surfactant-comprising aqueous solution and cooled. The cationic microparticles have a size of 0.1-0.5 μm and are incorporated into shampoos. The particles adhere on hair, the ingredients being released over a period of several hours. In contrast, EP 0369741 describes cationized porous microparticles having a diameter of preferably 10-40 μm whose pores can absorb hair care substances, sunscreens, perfume oils or insect repellents. A degree of loading of 5-65% is stated. The positive charge promotes adsorption on keratinic materials. The description mentions the possible use of methacrylates as copolymer. However, the preparation process is complicated. Including polymerization of the suspension, a plurality of washing steps for generating the porous structure, cationization by protonation of the particle surfaces and loading with the active compound, at least four steps are required. Moreover, it has not been demonstrated that the particles adhere to the hair for long.

Alternatively, WO98/28399 describes the suspension polymerization as a suitable method for generating polymer particles having a diameter of 10-150 μm, the polymer particles consisting of hydrophobic methacrylic esters, optionally copolymerized with other monomers, such as styrene. For the copolymerization, use is furthermore made of cationic monomers, preferably cationized (quaternized) dimethylaminoethyl methacrylates (component of Eudragit®) and crosslinking monomers. In this manner, the microparticles are provided with their cationic surface charge. The suspension polymerization is carried out in the presence of a polymerization stabilizer. Preference is given to using polyvinyl alcohol or cellulose esters. For their part, these hydroxyl group-containing polymers may also have cationic monomer units. The stabilizer is incorporated into the wall of the microparticle during particle formation. In this manner, the microparticles are provided with functional surfaces consisting of quaternary alkylammonium units and hydroxyl groups. The proportion of this polymer in the microparticles may be from 1 to 25%. According to the invention, this functionalization enhances adherence to fibres, even keratinic material (wool fibres). Preferably, these particles are then loaded with active compounds in the dynamic swelling process. Insecticides, insect repellents, perfumes, pheromones and other active compounds are mentioned. However, alternatively the active compound may also be incorporated during polymerization into the microparticles formed. The dispersions formed are virtually free of agglomerates and release the active compound on the fibre over a period of several days. However, this application does not describe applications on hair. In any case, the particles are too large for this purpose. Moreover, this process additionally requires a complicated polymerization step and optionally subsequent loading with active compound. Release over a period of several weeks has likewise not been demonstrated. The required free-radical polymerization may have a negative effect on the stability of many active compounds.

In contrast, it is obvious that the embodiment according to the invention represents a more simple method and leads directly to the active compound-loaded, cationically charged microparticles of a suitable dimension of 0.1-10 μm (preferably 0.1-3 μm). Moreover, the particles may comprise various proportions of Eudragit® types.

In principle, the solvent evaporation process for generating active compound-comprising microparticles of quaternized dimethylaminoethyl methacrylate copolymers (trade name Eudragit® RS, RL) is part of the prior art and has been described sufficiently. However, these processes have been applied and optimized for developing oral microcapsules with a prolonged release of the active compound. Here, active compound and Eudragit® polymers are dissolved in organic solvent and dispersed into an aqueous phase or an oil phase. The aqueous phase comprises emulsifiers, preferably polyvinyl alcohol or anionic or non-ionic surfactants. If an oil phase, for example paraffin oil, is used, use is frequently made of stearates. After removal of the solvent under reduced pressure—it is also possible to employ the solvent shift process—the microparticles remain in the dispersion. In most cases, the size is in the range of 10-1000 μm. As an example of such a process, IL 73597 may be mentioned. Here, the organic solvent used is tetrahydrofuran (THF). In WO92/01443, Eudragit® S 100 and Eudragit® RS 100 are dissolved together with preferably basic active compound in methylene chloride as solvent, and preferably dispersed in mineral oil comprising magnesium stearate. After evaporation of the solvent, the microparticles are finely divided in the dispersion. The particles have a size in the order of 0-150 μm, with <50 μm being preferred. The release of active compound is delayed and approximately independent of the pH of the environment. Drug Development and Industrial Pharmacy 16(13), 2057-2075 (1990) describes how nifedipine is dissolved in methylene chloride together with the polymers Eudragit® RS and RL. With the aid of a blade agitator, this solution is dispersed in the aqueous phase (emulsifier polyvinyl alcohol), and the solvent is evaporated. The size of the particles depends on the stirring speed, the proportion of polymer, the proportion of emulsifier, the viscosity of the oil phase, etc. There are numerous publications on this subject. Journal of Controlled Release, 16, 311-318 (1991) investigates the effect of the emulsifiers in the aqueous phase on release of encapsulated 5-aminosalicylic acid (solid dispersion in the CH₂Cl₂ phase). In the literature references mentioned, in most cases customary stirrer apparatuses are used to generate the emulsion. These applications and publications state that an emulsifier dissolved in the aqueous phase is necessary to prepare the emulsion and thus the microparticles.

Further examples from the extensive literature which may be mentioned are:
Eudragit® RS and RL (acrylic resin) microcapsules as pH insensitive and sustained release preparations of Ketoprofen; Goto S. et al.; J. Microencpasulation 3(4), 1986, 293-304
Evaluation of the sustained release properties of Eudragit® RS, RL and S (acrylic resins) microcapsules containing Ketoprofen beagle dogs; Goto S. et al., J. Microencapsulation 5(4), 1988, 343-360
A novel method for preparation of Eudragit® RL microcapsules; Satturwar P. M. et al., J. Microencapsulation 19(4), 2002, 407-413

However, all these processes lead to microparticles which are too big for application to hair. Also, these publications do not demonstrate that these particles bind to surfaces for long periods. Furthermore, to prepare the emulsions an emulsifier is required in the outer aqueous phase. Self-emulsifying effects of the Eudragit® polymer types are not described and do not come into effect in the processes mentioned above.

A totally different method of attaching active compound particles to animal hair is described in WO09/056,280. Here, functional antibodies are employed. The microparticles are functionalized on the surface by carboxyl groups. Through these groups, the antibodies are, in a multistep process, attached chemically to the microparticles. These antibodies have variable domains capable of specifically binding to the hairs of various species. However, owing to the requirement to attach the antibodies chemically to the surface and to maintain functionality for periods of times required by the applications, this process is likewise to be considered as complicated and expensive.

According to the invention, functional antibodies for mediating binding of the microparticles on animal hair are not required.

Thus, none of the methods and technologies listed can achieve the advantage of the present invention—a) the generation of microparticles for the delayed release of active compounds after adherence to hair, b) provision of a long-lasting adherence to hair by covering the surface of the microparticles with cationic polymers, c) sufficiently small size of the microparticles, such that there is no negative effect on hair properties, and d) simple preparation of the microparticles via an emulsion process.

Accordingly, it was an object of the invention to develop administration forms for topical applications in medicine, preferably veterinary medicine, which can meet the following complex demand profile:

a) being able to release active compounds slowly over a period of several days or weeks,
b) being able to substantially avoid skin irritation,
c) having no negative effect on functional and haptic properties of coat or skin and
d) at the same time being easy to produce.

This object is achieved according to the invention. The invention relates to:
1. Particles having a particle size d(v,90) of at most 10 μm comprising
   a) an uncharged polyacrylate and
   b) a cationic polyacrylate which carries positively charged functional groups,
   where the particles
   c) comprise one or more active compounds and
   d) may optionally comprise further polymers, auxiliaries or additives.
2. Particles according to item 1 having a particle size d(v,90) of 0.1-3 μm.
3. Particles according to item 1 or 2 in which the cationic polyacrylate b) is a quaternized dialkylaminoalkyl methacrylate copolymer.
4. Particles according to item 3 in which the cationic polyacrylate b) is a copolymer of (methyl, ethyl) acrylates, (methyl, ethyl) methacrylates and monochloromethane-quaternized dimethylaminoethyl esters of methacrylic acid (known under the trade name Eudragit RS or Eudragit RL).
5. Particles according to any of the preceding items in which the uncharged polyacrylate a) is poly(methyl methacrylate).
6. Particles according to any of the preceding items in which the mixing ratio of the uncharged polyacrylate a) to the cationic polyacrylate b) is from 5:95 (w/w) to 95:5 (w/w), preferably from 70:30 (w/w) to 95:5 (w/w), particularly preferably from 80:20 (w/w) to 90:10 (w/w).
7. Particles according to any of the preceding items comprising, based on the mass of the particles, 0.1-50% by weight, preferably 1-20% by weight, particularly preferably 5-15% by weight, of active compound.
8. Particles according to any of the preceding items where the uncharged polyacrylate has a weight average molecular weight of from 1000 g/mol to 1 000 000 g/mol, preferably from 20 000 to 600 000 g/mol, particularly preferably 50 000-150 000 g/mol.
9. Particles according to any of the preceding items comprising 0.1-50% by weight based on the total mass of the particles of one or more further polymers, preferably polystyrene.
10. Particles according to any of the preceding items comprising one or more plasticizers, surfactants, cosolvents, their sum, based on the total mass of the microparticles, being 0.1-40% by weight, preferably 5-30% by weight, particularly preferably 5-20% by weight.
11. Particles according to any of the preceding items comprising, as active compound, flumethrin.
12. Particles according to any of the preceding items comprising, as active compound, a repellent, preferably icaridin or N,N-diethyl-m-toluamide.
13. Particles according to any of the preceding items, comprising, as active compound, an arylpyrrolidine, preferably N-[[4-[3-(3,5-dichlorophenyl)-3-(trifluoromethyl)-1-pyrrolidinyl]-2-(trifluoromethyl)phenyl]methyl]propenamide (CAS No.: 1221692-86-9).
14. Process for preparing the particles according to any of the preceding items, comprising the following steps:
   (i) preparing a solution of components a) to d) in a solvent or solvent mixture (1) poorly miscible with water, if at all,
   (ii) dispersing the solution (i) in an aqueous phase optionally comprising additives and solvent or solvent mixture (1) to saturation, to obtain a fine, stable emulsion,
   (iii) removing the solvent or solvent mixture (1) from the emulsion droplets by
      I) evaporation (solvent evaporation process), to obtain an aqueous suspension, or
      II) spray drying, to obtain a dry powder.
15. Composition comprising particles according to any of items 1 to 13.
16. Composition according to item 15, where the particles are dispersed in a dispersion medium.
17. Use of the particles according to any of items 1 to 13 for preparing compositions for controlling parasites on animals.
18. Use of the compositions according to item 15 or 16 for repelling arthropods on animals.
19. Composition according to item 15 or 16 for use for controlling parasites on animals.
20. Composition according to item 15 or 16 for use for repelling arthropods on animals.

The particles according to the invention have a particle size d(v,90)<10 μm, preferably d(v,90)<5 μm, particularly preferably d(v,90)<3 μm, measured by laser diffraction using a Malvern Mastersizer® 2000. Preferably, the size of the particles according to the invention is at least d(v,90)>0.1 particularly preferably d(v,90)>0.3 particularly preferably d(v,90)>0.5 μm. Unless indicated otherwise, all particle sizes are d(v,90) values measured by laser diffraction (Malvern Mastersizer® 2000). d(v,90) is to be understood as meaning a volume-based particle size distribution where 90% of all particles have a dimension smaller than or equal to this value. The terms d(v,50), d(v,10) etc. are to be understood correspondingly. The measurement is carried out by the laser diffraction method using the Mastersizer® 2000 instrument (dispersing unit Hydro 2000G) from Malvern and the Fraunhofer diffraction evaluation mode, since the refractive indices of the active compound particles are not known. Here, a suitable amount of the sample solution is, with stirring, pre-dispersed in 2-3 ml of a dispersing medium (water or 0.1% aqueous dioctyl sodium sulphosuccinate solution). With stirring (300 rpm) and pumping (900 rpm), the dispersion is then transferred to the dispersing unit of the instrument and measured. The evaluation software states the particle size as d(v,0.5), d(v,0.9), etc., values.

The charged and uncharged polyacrylates form a matrix for the embedded active compound.

Uncharged polymers—in some publications and applications also referred to as neutral polymers—or uncharged polyacrylates are to be understood generally as polymers and specifically as polyacrylates which, in the sense of the Brönsted acid/base terminology, do not contain any groups which can be protonated or deprotonated in aqueous systems. In addition, it also refers to all polymers and specifically polyacrylates which contain no permanently anionic or cationic groups and therefore retain their charge state in acidic or basic aqueous solution. As a result, they are insoluble in water, a further essential property of the uncharged polyacrylates used for the purpose of the invention. Accordingly, the microparticles formed therefrom remain intact in water and in the microclimate of the animal coat, and they are also not swellable to any measurable extent. In this manner only, the active compounds comprised in the microparticles can be released in a delayed and controlled manner by diffusion. For the definition above, it is immaterial whether the uncharged polyacrylates comprise, for example owing to the production method, very small proportions of charged, protonatable or deprotonatable groups. In the case of acrylic or methacrylic esters, for example, it is possible that they may comprise small proportions of non-esterified carboxyl groups. These can be considered as a kind of unwanted “contamination”, and they are not to be taken into account when assessing whether a polyacrylate is “uncharged” for the purpose of the invention. Uncharged polyacrylates for the purpose of the invention are not only polymers of acrylic esters (polyacrylates in the narrower sense of the word), but also those of derivatives of the acrylic esters. The esters are preferably alkyl esters, the alkyl group preferably containing 1 to 4 carbons; very particular preference is given to methyl esters. The derivatives are in particular alkyl poly(alkyl)acrylates, where the alkyl substituent of the alkylacrylic acid and the alkyl group of the ester independently of one another may be alkyl having 1 to 4 carbon atoms; particular preference is in each case given to the methyl group. The alkyl poly(alkyl)acrylates are used with particular preference and can be represented by the following general formula:

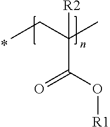

R¹=alkyl, preferably having 1 to 4 carbon atoms, in particular —CH₃
R²=alkyl, preferably having 1 to 4 carbon atoms, in particular —CH₃

A very particularly preferred uncharged polyacrylate for the matrix is methyl polymethacrylate (poly(methyl methacrylate), PMMA).

As uncharged polyacrylates for the matrix, it is also possible to use uncharged copolymers of the abovementioned uncharged polyacrylates, or mixtures of different uncharged polyacrylates.

The molar masses of the uncharged polyacrylates of the matrix, for example PMMA, may vary within wide limits. It is expedient to use molecular weights of M_{w}=1000 g/mol to 1 000 000 g/mol (weight average). However, particularly suitable is a mean molecular weight range of 20 000-600 000 g/mol, and here, in turn, particularly preferably 50 000-150 000 g/mol. Polyacrylate polymers having a low molecular weight are particularly suitable for admixing in order to lower the glass transition temperature of the microparticles, or to generate particularly small microparticles of d(v,90)<2 μm (to this end, use is preferably made of molecular weights M_{w}<10 000 g/mol). As already stated above, the microparticles may optionally also comprise varying proportions of further uncharged alkyl polyalkyl acrylates.

In contrast, anionic polymers, specifically anionic polyacrylates, are not used for the purpose of the invention. Anionic polymers are to be understood as meaning polymers containing functional groups which can be deprotonated in the sense of a Brönsted acid in an aqueous environment and/or contain functional groups which are permanently negatively charged. A specific example which may be mentioned are Eudragit® S types. Such polymers are unsuitable, since they weaken, neutralize or even convert into the negative the positive surface charge of the microparticles, which would reduce the adherence of the microparticles to the positively charged hair surfaces.

The cationic polyacrylate carries positively charged functional groups and is preferably a polyacrylate in the narrower sense of the word, a polymethacrylate or a copolymer derived therefrom. The alkyl group of the ester and, if appropriate, the alkyl substituent of the alkylacrylic acid denote independently of one another alkyl having 1 to 4 carbon atoms; particular preference is in each case given to the methyl group. The positively charged group is preferably attached via the ester group to the polyacrylate skeleton. Usually, an amino or ammonium group is attached via an alkyl chain having 1 to 4 carbon atoms, preferably an ethylene chain, to the oxygen of the ester group. The positively charged group is preferably a trialkylated and protonated or a tetraalkylated amino group, the alkyl groups independently of one another having 1 to 4 carbon atoms, preferably 1 or 2 carbon atoms. Very particular preference is given to cationic water-insoluble copolymers of dimethylaminoethyl methacrylate, (ethyl,methyl) acrylate and (ethyl,methyl) methacrylate having the trade name Eudragit® RS or RL (manufacturer and distribution: EVONIK Industries, as at 2011), in which the tertiary amino group is quaternized with methyl chloride (CAS No. 33434-24-1; the polymers of the Eudragit® RL and RS types have already been described in detail above). The cationic polyacrylates preferably have a weight-average molecular weight of from 20 000 to 40 000, preferably from 25 000 to 35 000. The cationic polyacrylate is a separate component of the particles according to the invention; it is not copolymerized with the uncharged polyacrylates of the matrix.

Surprisingly, such cationic polymers provide a property profile which, in combination with the uncharged polyacrylate matrix polymer(s), allows all four of the complex requirements a) to d) for the administration form to be achieved. The use of cationic polymers, in particular Eudragit® RS, RL, allows a simple preparation process which generates small microparticles having a cationic surface charge and which, from an aqueous formulation, can adhere efficiently to the negatively charged animal hair and are small enough, so that they don't effect negatively the optical or haptic properties of the coat after drying. Moreover, long-lasting adherence of the particles on the animal hair may also be achieved after drying. By combining various ratios of the different polymer types (matrix polymer and cationic polyacrylate), it is possible to modify the particle size and to achieve delayed, continuous and longer-lasting release of the active compound(s) from the particles. The proportion of cationic polymer may be varied within wide limits of 5-95% by weight, preferably 5-30% by weight, but particularly preferably 10-20% by weight, based on the proportion of polymer.

The particles according to the invention may also be referred to as microcapsules in which the active compounds are stored or encapsulated. In the particles, the active compounds are dissolved in molecularly dispersed form or suspended in disperse form. Accordingly, the microparticles form an active compound reservoir. The polymer matrix may also comprise other polymers and additives. As a further characteristic of the invention, it may be mentioned that the cationic polyacrylate and also further additives are miscible with the matrix polymer(s). Further additives and polymers have to be chosen such that there is no phase separation within the polymer matrix of the particle. The proportion of the additives mentioned, such as, for example, further polymers or plasticizers, in the microparticles may be up to 40% in total, based on the total weight of the particles.

The preparation of the particles can take place by various processes. The particle properties according to the invention can be modified by the preparation process. Thus, the solvent evaporation process is the preferred process to obtain particles of the size according to the invention and a modified surface. There are many descriptions of this process in the literature, in different variations. Here, the components of the particles are dissolved in an organic solvent which is immiscible with water, and the solvent is then—in most cases with the aid of an emsulifier—dispersed in an aqueous phase, such that initially an emulsion is formed. By warming this emulsion, the organic phase is evaporated and the solvent base of the dissolved components is removed. By adjusting the temperature in a suitable manner, the solvents can be removed almost completely from the microparticles. The solids of the emulsion droplets remain in the form of microparticles. In this manner, the emulsion is converted into a suspension. If required, further formulation components may be added to this suspension. After bottling, the formulation obtained can be applied directly. Thus, the formulation can be prepared in one step (one-pot process). The particles may be purified and isolated by subsequent washing and filtration steps, if this is advantageous for the application.

In the case according to the invention, a cationic surface charge of the particles is required for later application. This is achieved by the cationic polyacrylate. Together with the matrix polymers, the active compound(s) and optionally additives, the cationic polyacrylate is dissolved in the oil phase. In the present invention, the volume ratio of the organic solvent with respect to the aqueous phase may be varied within wide ranges. Thus, volume ratios of from 10:90 to 50:50 (organic solvent: aqueous phase) are possible. Preference is given to proportions by volume of organic phase to aqueous phase of from 20:80 to 40:60, whereby, using suitable dispersing conditions—for example when using a high-performance dispersing apparatus and/or a high-pressure homogenizer—and variation of energy input the droplet size of the emulsion and thus ultimately the size of the microparticles may be varied. The organic solvent must be poorly miscible with the aqueous phase, if at all, and has to evaporate at temperatures below the boiling point of the water. These requirements can be met in particular by halogenated hydrocarbons and also by ethyl acetate. For the purpose of the invention, preference is given to dichloromethane, trichloromethane and ethyl acetate.

According to the invention, the cationic polyacrylate now acts as emulsifier. For example, the water-insoluble cationic Eudragit® RL(RS), which is preferably used, has, in the use according to the invention, in addition to compatibility with the matrix polymer, also remarkably good emulsifying properties, and it is therefore possible to generate particularly finely divided oil-in-water emulsion droplets. This is particularly surprising, since according to conventional teaching a suitable emulsifier has to be soluble mainly in the aqueous phase in order to generate oil-in-water emulsions. After removal of the solvent, the active compound-comprising microparticles are present in the form of an aqueous dispersion. The microparticles now also have a cationic surface charge. As a consequence, the microparticles, applied as an aqueous dispersion formulation, can now be bound preferably on the negatively charged surfaces of the animal hairs. The properties of the quaternized dimethylaminoethyl methacrylate copolymer of the Eudragit® RS, RL type result in a particularly good adherence to hair and ensure that the microparticles adhere to the dry animal hairs even long after the aqueous formulation base has dried off. This avoids direct contact of the active compounds with the skin, and the skin-irritating action of some active compounds does not come into effect. In addition, during this period, the active compound is released from the microcapsules in a delayed manner. The release properties of the microparticles may additionally and in wide ranges be varied by further additives (for example plasticizers, addition of other polymer types, ratio matrix polymer/Eudragit®).

The high-performance dispersing apparatus used may be, for example, an Ultra Turrax® T25 from IKA Werke GmbH & Co. KG. A typical operating range during the preparation of the microparticles according to the invention is a number of revolutions of about 10 000 rpm with a period of application of 1-3 minutes. The high-pressure homogenizer used may be, for example, of type M110Y from Microfluidics. In the context of the present invention, the microparticles were, as standard, prepared using a pressure (flow pressure) of 500 bar and an interaction chamber pore size of 200 and 100 μm.

A further, less preferred process for preparing particles according to the invention is spray drying. To this end, the procedure of the emulsion evaporation method is adopted, and after dissolution, the particle components are converted into an emulsion. The latter may be atomized and dried using a two-fluid nozzle.

Less preferred, but also possible, is a subsequent loading of the particles by the dynamic swelling process. To this end, the placebo particles (i.e. particles according to the invention not yet comprising any active compounds) are dispersed in a suitable solvent. The solvent has to dissolve the active compound and swell the particles. Owing to this swelling process and driven by the establishment of a distribution equilibrium in favour of the organic polymer phase, it is possible for the active compound to diffuse into the particles. By slowly removing the solvent, the swelling of the particles recedes and the active compound remains in the microcapsules.

Preference is given to using active compounds which can be applied externally. Examples which may be mentioned are active compounds from the group of the insecticides, parasiticides, acaricides, fungicides, the repellents, dermatologically active compounds or active compounds acting by modifying behaviour. Such active compounds modifying behaviour include, for example, pheromones or similar odourous substances associated with reproductive behaviour.

There are other systems suitable only for charged active compounds; however, the particles according to the invention are also suitable for uncharged active compounds. Thus, particles according to the invention comprising an uncharged active compound represent one embodiment of the present invention. “Uncharged active compounds” are active compounds which do not contain any permanently positively or negatively charged groups, i.e. which are neutral, and are present in this neutral uncharged form in the particles. If the compounds may be present in charged forms depending on the pH, “uncharged active compounds” are preferably considered to be those which, at pH 5-9, in particular pH 6-8, are present predominantly in a neutral uncharged form.

In principle, all active compounds which are suitable for external application and which the person skilled in the art can think of may be used according to the invention. Accordingly, the active compounds and active compound groups mentioned hereinbelow are mentioned only as examples and are not to be considered as limiting.

Preference is given to using active compounds against ectoparasites on animals and humans, in particular active compounds having insecticidal and/or acaricidal action.

A preferred group of active compounds which may be mentioned are the pyrethrins, and also the pyrethroids, for example: fenvalerate [α-cyano-3-phenoxybenzyl α(p-Cl-phenyl)isovalerate, flumethrin [(α-cyano-4-fluoro-3-phenoxy)benzyl 3-[2-(4-chlorophenyl)-2-chlorovinyl]-2,2-dimethylcyclopropanoate] and its enantiomers and stereoisomers, cyfluthrin [(α-cyano-4-fluoro-3-phenoxy)benzyl 2,2,-dimethyl-3-(2,2-dichorovinyl)cyclopropanecarboxylate], permethrin [3-phenoxybenzyl cis,trans-3-(2,2-dichlorovinyl)-2,2-dimethylcyclopropanecarboxylate], cypermethrin [α-cyano-3-phenoxybenzyl 2,2-dimethyl-3-(2,2-dichlorovinyl)cyclopropanecarboxylate], deltamethrin [α-cyano-3-phenoxybenzyl cis,trans-3-(2,2,-dibromovinyl)-2,2-dimethylcyclopropanecarboxylate], fluvalinate [2-cyano-3-phenoxybenzyl 2-(2-chloro-α,α,α-trifluoro-p-toluido)-3-methylbutyrate]. Preference is given to using pyrethroids having acaricidal action. Particularly preferred are α-cyanopyrethroids, in particular the esters of the α-cyano-3-phenylbenzyl alcohols and the 4-fluoro-α-cyano-3-phenoxybenzyl alcohols. From among these, cyfluthrin, β-cyfluthrin or in particular flumethrin are especially preferred.

A further α-cyanopyrethroid which may be mentioned is cyphenothrin. The pyrethroids also include etofenprox, even though it has a slightly different basic structure.

A further preferred group of active compounds are repellents. Repellents are active compounds which are detected by an organism usually via the sense of smell, and which repel this organism without directly killing it. For example, pyrethroids have a repellent and an insecticidal or acaricidal action. Other repellents have virtually no relevant insecticidal or acaricidal action. Preference is given to using repellents which repel harmful or nuisance insects such as mosquitoes, flies, fleas or acarids such as ticks or mites from animals and humans. As preferred examples of the group of the repellents, the following may be mentioned here: DEET diethylenetoluamide), icaridin, ethyl butylacetylaminopropionate (IR3535, MERCK). The duration of action of conventional commercial formulations to be applied topically is in most cases limited to a few hours.

In addition, the arylpyrrolidines form a further preferred group of active compounds which may be encapsulated in the microparticles according to the invention. Here, particular mention may be made of N-[[4-[3-(3,5-dichlorophenyl)-3-(trifluoromethyl)-1-pyrrolidinyl]-2-(trifluoromethyl)phenyl]methyl]propenamide (CAS No.: 1221692-86-9).

From the group of the insecticides, those used in the field of controlling ectoparasiticidal arthropods, such as spinosyn, N-phenylpyrazoles, carbamates, phosphoric and phosphonic esters, growth inhibitors, juvenile hormones and mixtures of these active compounds with one another may be mentioned as being preferably used. It is also possible to add further synergists. For the purpose of the present application, synergists are to be understood as meaning compounds which for their part do not have the desired activity, but which, as mixing partners, increase the activity of the active compounds.

Carbamates which may be mentioned are substituted phenyl and naphthyl carbamates.

Phosphoric esters which may preferably be mentioned are the compounds having the common names phoxim, fenitrothion, dichlorvos, trichlorfon and malathion.

All active compounds mentioned according to the invention may, if appropriate, be employed either as mixture of stereoisomers, for example as mixture of diastereomers or racemate, or else as enriched or substantially pure stereoisomer, for example enantiomer.

Of course, it is also possible to use combinations of active compounds in the particles according to the invention.

In the particles according to the invention, the active compounds are usually present in concentrations of 0.1-50% by weight, preferably 1-20% by weight, particularly preferably 5-15% by weight, in each case based on the weight of the particles.

Precondition for the incorporation of the active compounds into microparticle is the compatibility with the polymer matrix. Hereinbelow, polymer matrix is to be understood as meaning the mixture of the matrix polymer polyacrylate (preferably PMMA) and the cationic polyacrylate (preferably Eudragit® RL/RS) and any further polymers optionally added. It is favourable for a long-lasting release of the active compound from the microparticles if the active compound is present in the particles dissolved in molecularly dispersed form, or at least in particulate amorphous form, i.e. not crystalline. Particularly preferred is a molecularly dispersed distribution of the active compound in the matrix polymer in the sense of a solid solution. This may be given, in one case, by a compatibility in principle in the sense of a thermodynamic miscibility of active compound and polymer matrix. The advantage of such a miscibility consists in the fact that a rapid diffusion of the active compounds from the matrix to the surface of the particles is prevented (principle of phase separation). A molecularly dispersed distribution may be demonstrated, for example, when no melting peaks of the active compounds can be found in DSC/DTA diagrams. An alternative method is analysis by X-ray diffractometry. In this method, miscibility is distinguished by the absence of diffraction peaks. However, for the purpose of the invention, it should not be excluded that at least a certain proportion of the active compounds may be present crystalline enclosed in the polymer matrix, whereby the release rates, for example, may be modified further.

However, the use of active compounds for the purpose of the invention is not limited to active compounds which are miscible with the polymer matrix in a thermodynamically stable manner. For producing the active compound-comprising microparticles according to the invention, use may also be made of all processes known to the person skilled in the art which increase the molecular miscibility of the active compounds with the polymer matrix. As in the case of liquid solutions, one or more solubilizers may be used for this purpose. This can be achieved, for example, by addition of further polymers, of plasticizers, cosolvents, wetting agents (surfactants) or else further active compounds which prevent demixing, phase separation or crystallization of the active compound or else other components in the microparticles. By addition of these substances, it is also possible to moderate the release behaviour of the active compounds from the microparticles. In general, the addition of the low-molecular-weight additives mentioned lowers the glass transition temperature and thus increases the diffusion rate of the active compounds in the matrix, so that, if desired, an accelerated release may be achieved.

Optional added polymers are, in general, all types of polymer miscible with the matrix polymer polyacrylate and the cationic polyacrylate and the active compounds incorporated into the microparticles. Preference is given to using other polyvinyl resins such as polyvinylpyrrolidone, polyvinyl chloride, polyvinylpyrrolidone/polyvinyl acetate copolymers (trade name Luviskol), but in particular polystyrene. Derivatives of polymeric—at least partially hydrophobic—carbohydrate compounds, for example cellulose ethers, cellulose esters, hydrophobized starch, may also be mentioned here, likewise polyethylene glycols (polyoxyethylene, macrogol, CAS No. 25322-68-3). Their proportion may be up to 50% by weight, based on the total mass of the microparticles; preference is given to using 10-40% by weight.

The microparticles according to the invention may comprise plasticizers. Suitable for use as plasticizers are all pharmaceutically acceptable compounds miscible with the matrix polymer and known to the person skilled in the art which have a desired effect, lower the glass transition temperature and/or increase the miscibility of the active compound with the matrix polymers. In this manner, it is also possible to increase the rate of release of the active compounds from the microcapsules. Examples which may be mentioned are: phthalic and terephthalic esters, triethyl citrate, triacetin, lecithins, phosphoric esters, adipic esters, benzyl benzoate, tributyl acetylcitrate, ascorbyl palmitate, ethyl oleate and fatty acid esters of polyhydric alcohols, such as of glycerol and of propylene glycol (miglycols). Preference is given to using benzyl benzoate, tributyl acetylcitrate, triethyl citrate. The plasticizer is usually added in the amount required to achieve the intended lowering of the glass transition temperature and increase of the release rate. The amount required may vary within wide ranges; however, an upper limit of 40% by weight, based on the total mass of the particles, has been found to be useful. The amount employed preferably varies between 10 and 30% by weight.

The microparticles according to the invention may also comprise pharmaceutically acceptable cosolvents which are miscible with the polymer material, which act as solubilizers and also as plasticizers, but which may also have an effect on the distribution coefficient of the active compound between the particle phase and the dispersing medium. However, the distribution equilibrium of the cosolvents which can be used for this purpose has to be predominantly on the side of the polymer/active compound/solvent phase to avoid diffusion into the outer aqueous phase during the emulsification process. These cosolvents are usually employed in proportions of preferably 5 to 20% by weight, based on the proportion of polymer. Pharmaceutically acceptable, relatively long-chain alcohols, such as n-butanol, benzyl alcohol, or esters such as triacetin, ethyl oleate, benzyl benzoate may be mentioned, for example, as suitable cosolvents. It is also possible to use mixtures of the solvents mentioned above as cosolvent. Of course, it is also possible to employ other cosolvents which can be used for this purpose. Particular preference is given to benzyl benzoate.

The microparticles according to the invention may furthermore also comprise pharmaceutically acceptable surface-active compounds (surfactants) miscible with the polymer material, which surfactants may likewise act as solubilizers and plasticizers, but which may also have an effect on the distribution coefficient of the active compound between the particle phase and the dispersing medium. However, here, too, the distribution equilibrium of the surface-active compounds which can be used for this purpose must be predominantly on the side of the polymer/active compound/solvent phase to avoid diffusion into the outer aqueous phase during the emulsification process. It is possible to use mainly hydrophobic surfactants and wetting agents having an HLB value (hydrophilic-lipophilic balance value, determined by the Griffin method) of <8. These surfactants and wetting agents can usually be employed in proportions of preferably 5 to 20% by weight, based on the proportion of polymer. Preference is given to non-ionic surface-active compounds. Examples which may be mentioned are: fatty alkyl polyethylene glycol ethers, alkylphenol polyethylene glycol ethers, polyoxyethylene fatty acid glycerides, polyoxyethylene fatty acid esters, in each case having a low degree of ethoxylation, allyl polyglycosides, fatty acid N-methylglucamides, hydrophobic polysorbates, sorbitan fatty acid esters, lecithins and poloxamers having a higher proportion of polypropylene oxide. It is, of course, also possible to employ further surface-active compounds (surfactants) known to the person skilled in the art which have the desired effect, lower the glass transition temperature and/or increase the miscibility of the active compound with the matrix polymers.

If the active compounds are preferably present in the polymeric carrier matrix in molecularly dispersed form, they can be released by diffusion from the matrix into the surroundings of the microparticles. This diffusion is decisive for the long-lasting action on the animals. The release duration may be achieved by moderating the rate of diffusion of the active compounds in the microparticles. Here, too, it is possible to employ, according to the invention, all methods known to the person skilled in the art. In the sections above, the addition of plasticizers, cosolvents, surfactants and other additives which lower the glass temperature of the matrix polymer have already been mentioned. A particular option of modification which may additionally be mentioned here is the use of polymers of different molecular weight. The addition of polymers having a low molecular weight likewise lowers the glass transition temperature and can thus modulate the diffusion rate of the active compounds in the polymer matrix and thus also the release rate (see also example 4).

Of course, the microparticles according to the invention may comprise all further additives known to the person skilled in the art which increase the stability of the encapsulated compounds or other active compounds or improve the consistency of the microparticles, provided they are miscible with the matrix material. Examples which may be mentioned are: antioxidants, preservatives, fillers.

Antioxidants which are particularly suitable for incorporation into the microparticles are the more hydrophobic representatives. Examples which may be mentioned are: phenols (tocopherols, such as vitamin E, for example, butylhydroxyanisole, butylhydroxytoluene, bile acid esters such as, for example, octyl and dodecyl gallate, ascorbyl palmitate, and also further suitable esters of organic acids, mercapto compounds, for example thioglycerol, thiolactic esters. The antioxidants mentioned may be employed in all concentration ranges sufficient to ensure an antioxidant protective action; a customary concentration range is 0.01-0.1% by weight.

More hydrophobic preservatives would be, for example: benzyl alcohol, n-butanol, phenol, cresols, chlorobutanol, para-hydroxybenzoic esters, in particular the propyl ester. The preservatives mentioned can be employed in all concentration ranges sufficient to ensure protective action against microbes; however, a customary concentration range would be 0.01-5% by weight.

The microparticles according to the invention are usually introduced into a suitable administration form (formulation). They can be applied in the form of a powder, but preferably as a dispersion, more accurately as a suspension, to the animal. From among the dispersions, preference is given to aqueous dispersions. The preparation process described already provides ready-to-use aqueous dispersions as a base for the formulation. All pharmaceutical auxiliaries and additives known to the person skilled in the art which have an effect on its shelf-life, stability and applicability can now be added to this suspension. Of course, the auxiliaries and additives should be compatible with the dispersing medium; i.e. in the case of the preferred aqueous dispersing medium, the auxiliaries and additives should be predominantly hydrophilic and thus miscible with water. Auxiliaries and additives which may be mentioned are, for example, dispersants, wetting agents (surfactants), spreading agents, preservatives, antioxidants, pH regulators, antifoams. It is also possible to employ thickeners and texturizing ingredients to adapt the rheological properties of the dispersion formulations to the requirements. The addition of miscible organic solvents to the outer phase may be a further means to moderate the release profiles of the active compounds from the microparticles in the sense that a certain proportion, which can be adjusted to a fixed value, of the active compounds is already present in saturated dissolved form in the outer phase of the dispersion, thus ensuring the required knock-down effect on the parasites immediately after application of the formulation.

Suitable dispersing media for the microparticles are, in general, homogeneous solvents and solvent mixtures with additives which do not dissolve the microparticles and do not dissolve the active compounds from the mciroparticles. Preference is given to using water or mixtures of water and water-miscible solvents, where the mixing ratio of the water to the water-miscible solvent may be varied as desired as long as the microparticles are not dissolved or swell greatly and the active compound is not dissolved from the microparticles. To prevent dissolution of the active compound from the microparticles, the dispersing medium may also comprise the dissolved active compound, up to the saturation limit. Water-containing dispersing media usually comprise at least 50% by weight, preferably from 70 to 95% by weight, of water. The concentration of the microparticles in this dispersing medium may vary within wide ranges. Particle concentrations of 1-30% by weight have been found to be suitable. Preference is given to 1-20% by weight, particularly preferably 5-15% by weight.

Suitable for use as dispersants are all additives known to the person skilled in the art which adsorb on the surfaces on the microparticles or facilitate a homogeneous distribution of the microparticles in the dispersion formulation: polyvinylpyrrolidone, polyvinyl alcohol, cellulose ethers and esters and also poloxamers (polyethylene glycol/polypropylene glycol/polyethylene glycol three-block copolymers) may be mentioned as being preferred. The dispersants mentioned are preferably employed in concentration ranges of 0.05-3% by weight.

Possible additives from the group of the wetting agents and surfactants are preferably more hydrophilic, non-ionic and cationic representatives having an HLB value of more than 8, such as, for example, fatty alkyl polyethylene glycol ethers, alkylphenol polyethylene glycol ethers, alkyl polyglycosides, polyethoxylated fatty acid glycerides, polyethoxylated fatty acid esters, fatty acid N-methylglucamides, polysorbates, sorbitan fatty acid esters, poloxamers, polyethoxylated castor oil derivatives. Polyethoxylated sorbitan fatty acid esters and poloxamers are to be mentioned as being preferred. Anionic surfactants would adsorb on the surface of the microparticles and reduce the cationic surface charge. For this reason, they are less suitable. Suitable use concentrations of dispersants and wetting agents and also surfactants are determined by the particle concentration and the total surface of the microparticles in the formulation and may vary within wide ranges. The concentration of micelle-forming wetting agents and surfactants is preferably chosen such that the critical micelle formation concentration (cmc) is not exceeded.

Preferred for use as spreading agents are water-miscible compounds such as, for example, non-ionic surfactants and silicone surfactants, but in a low concentration, still miscible with the dispersant, and also oily systems, such as isopropyl myristate, fatty acid esters, fatty alcohols, adipic esters, triglycerides. Frequently, concentration ranges of 0.01-1% by weight have been found to be suitable for the spreading agents. However, these concentrations, also those in the sections below, are not to be understood as limiting and may vary depending on auxiliaries and further formulation components.

Preservatives may also be present in the liquid formulations. By virtue of their cationic charge, quaternary ammonium compounds are particularly suitable since, on adsorption on the surface of the particle, they do not reduce its positive charge. Benzalkonium chloride and cetylpyridinium chloride, for example, may be mentioned here. Examples of further preservatives which may be used are those mentioned below: aliphatic alcohols, such as benzyl alcohol, ethanol, butanol, phenol, cresols, chlorobutanol, para-hydroxybenzoic esters, in particular the methyl and propyl esters, salts or the free acids of the carboxylic acids, such as sorbic acid, benzoic acid, lactic acid, propionic acid. The preservatives are to be added in the pharmaceutically customary and microbiologically effective amounts. Concentration ranges which are used are, for example, 0.01-5% by weight. They may be added either individually or in combination with synergists. Synergists which may be employed are, for example: citric acid, tartaric acid, ascorbic acid, or the sodium salt of editic acid.

The addition of antioxidants may be useful if the active compound or other auxiliaries dissolved in the continuous aqueous phase is sensitive to oxidation.

Antioxidants which may be used are, for example: sulphites (sodium sulphite, sodium metabisulphite), organic sulphides (cystine, cysteine, cysteamine, methionine, thioglycerol, thioglycolic acid, thiolactic acid), phenols, tocopherols such as vitamin E, butylhydroxyanisole, butylhydroxytoluene, bile acid esters, for example octyl and dodecyl gallate, organic acids (ascorbic acid, citric acid, tartaric acid, lactic acid) and their salts and esters. Antioxidants are usually added in amounts of 0.01-1% by weight.

Thickeners and texturizing ingredients are inorganic thickeners such as bentonites, colloidal silicic acid, aluminium stearates, and organic thickeners such as cellulose derivatives, for example methylcellulose, carboxymethylcellulose and salts thereof, hydroxyethylcellulose, hydroxypropylmethylcellulose 4000, polyvinyl alcohols and their copolymers, polyacrylic acids (carbopols), polyacrylates such as polyethyl and methacrylates, mixtures of micronized cellulose and sodium carboxymethylcellulose, polymeric hydrocarbons such as, for example, xanthan gum, alginates, gum Arabic, polypeptides such as gelatine, polyvinylpyrrolidones, polyvinyl alcohols, starch derivatives, copolymers of methyl vinyl ether and maleic anhydride. Mixtures of these substance classes may be particularly advantageous. In most cases, amounts of 0.01-5% by weight are sufficient in order to achieve the required thickening effect.

pH regulators are pharmaceutically customary acids or bases. The bases include alkali metal or alkaline earth metal hydroxides (for example NaOH, KOH), basic salts such as, for example, ammonium chloride, basic amino acids such as, for example, arginine, choline, meglumine, ethanolamines, or else buffers such as, for example, tris(hydroxymethyl)aminomethane, citric acid buffers or phosphate buffers. The acids include, for example, hydrochloric acid, acetic acid, tartaric acid, citric acid, lactic acid, succinic acid, adipic acid, methanesulphonic acid, octanoic acid, linolenic acid, gluconolactone, and also acidic amino acids such as, for example, aspartic acid.

Antifoams are preferably those based on silicone, for example dimeticone or simeticone. Here, frequently, even very small amounts of 0.001-0.01% by weight are effective.

The use of water-miscible solvents in the aqueous phase of the dispersion formulation may be useful, for example in order to adjust the saturation concentration of the active compound in the continuous phase to a required value. However, the additives have to be chosen carefully, and their concentration has to be limited, since solvents and cosolvents must not compromise the integrity of the microparticles and dissolve relatively large amounts of the active compounds from the microparticles. If water-miscible solvents are added, the amounts employed are preferably 5-30% by weight. Suitable solvents are, for example: physiologically acceptable solvents such as alcohols, such as, for example, monohydric alkanols (for example ethanol or n-butanol), polyhydric alcohols, such as glycols (for example ethylene glycol, propylene glycol, tetraglycol/glycofurol), polyethylene glycols, polypropylene glycols, glycerol; aromatically substituted alcohols such as benzyl alcohol, phenylethanol, phenoxyethanol; esters, such as ethyl acetate, butyl acetate, ethers such as alkylene glycol alkyl ethers (for example dipropylene glycol monomethyl ether, diethylene glycol monoethyl ether); ketones such as acetone, methyl ethyl ketone; glycerol formal, solketal (2,2-dimethyl-4-hydroxymethyl-1,3-dioxolane), N-methylpyrrolidone, 2-pyrrolidone, N,N-dimethylacetamide, dimethyl isosorbite, lauroglycol, propylene carbonate, dimethylformamide, and also mixtures of the solvents mentioned.

To prepare the liquid formulations according to the invention, appropriate amounts of the desired components are mixed with one another, for example using conventional stirring tanks or other suitable apparatus. If required for the ingredients, the operations can be carried out under a protective atmosphere or using other methods of excluding oxygen.

By virtue of their positive surface charge, the microparticles according to the invention, applied as an aqueous dispersion formulation, adsorb rapidly and preferably on the negatively charged surfaces of the animal hairs and, because of the particular properties of the cationic polyacrylates used according to the invention, remain adhered on the coat of the animal for days and weeks. Over this entire period, the active compound can be released from the microparticles, thus displaying its treating or protecting action over a prolonged period of time. Owing to the adherence of the microparticles on the animal hair, direct contact with the skin is substantially avoided and the skin-irritating action of many active compounds does not come into effect. Furthermore, by virtue of the small size of the microparticles, the visual and haptic properties of the coat are not negatively affected. A further advantage of the invention is the fact that microparticles comprising different active compounds can be mixed in a dispersion formulation, so that active compounds which are otherwise chemically incompatible can be applied jointly in one formulation.

The application of the particles to the coat is carried out from an aqueous suspension, for example as spray, spot-on, pour-on, pump spray, aerosol spray or wipe-on formulation. A wipe-on formulation is an administration form where the formulation—advantageously using a suitable applicator—is spread on the coat of the animal or incorporated into the coat of the animal. Here, preference is given to a pour-on and a wipe-on formulation or a pump spray administration. The wipe-on application may be mentioned as being particularly preferred. To this end, using the active compound content of the microparticles, the required amount of particles is determined. The required application volume is calculated using the solids concentration in the microparticle suspension. For easier application, a surfactant (for example Tween 20, 0.01%) is added to the aqueous dispersion. This allows better wettability of the coat. The formulation is either sprayed on or rubbed into the coat. To this end, suitable applicators are used.

The formulations according to the invention are preferably suitable for external use on animals, preferably warm-blooded animals, such as, for example, birds or in particular mammals. These may be domestic animals and useful animals, and also zoo animals, laboratory animals, test animals and pets.

The useful and breeding animals include mammals such as, for example, goats, camels, water buffalo, donkeys, rabbits, fallow deer, reindeer, fur-bearing animals such as, for example, mink, chinchilla, raccoon, and also, in particular, cattle, horses, sheep, pigs.

The laboratory animals and test animals include mice, rats, guinea pigs, golden hamsters, dogs and cats.

The pets include dogs, cats and horses.

Particular emphasis is given to application on cat, dog or horse.

According to the invention, application to animals includes the application to humans.

Application can take place both prophylactically and therapeutically.

Ultimately, the use and the active spectrum of the particles according to the invention and the compositions comprising them depends on the active compound comprised therein or the active compounds comprised therein; the respective activity spectra and fields of use are known in principle to the person skilled in the art. The particles according to the invention and their formulations are preferably used for controlling parasites, in particular ectoparasites, on animals. Parasites which may be mentioned are insects such as, for example, fleas, lice, mosquitoes, flies, etc., and acarids such as, for example, ticks and mites. Particular emphasis is given to the use against fleas and ticks.

The examples below are meant to illustrate the invention:

### EXAMPLES

### Example 1

The particles are prepared using the emulsion evaporation process. The composition of the particles can be seen from the table below.

TABLE 1
Feed materials

| Feed materials | Amount |
|---|---|
| Demin. Water | 160 ml |
| Dichloromethane | 40 ml |
| PMMA | 3.70 g |
| Eudragit ® RS 100 | 0.74 g |
| Flumethrin | 0.88 g |

Flumethrin, PMMA (Terez® PMMA 5003, Ter Hell Plastics GmbH, Mw=94 000 g/mol) and Eudragit® RS 100 (Mw=˜30 000 g/mol; Evonik Industries AG) are dissolved in the organic phase (dichloromethane). Using the Ultra Turrax® (T25, IKA® Werke GmbH & Co. KG), the organic phase is dispersed in the aqueous phase by slow addition (9500 rpm, 2 min.). This gives a stable emulsion which is then homogenized more intensively using a high-pressure homogenizer (Microfluidizer M110Y, microfluidics, at a flow pressure of 500 bar). The organic phase is removed by gentle heating (max. 60° C.) with stirring using a magnetic stirrer. The dissolved components harden, giving a particle suspension. This is then filtered using a stirred cell (Millipore Solvent-resistant Stirred Cell, for 47 mm membranes, Cat No XFUF04701; Millipore GmbH) and suitable filters (Pall Ultipor N66/0.2 μm, Cat No. NRG047100; Pall Corporation) and purified in subsequent wash steps using water. The particles are then characterized:
a) Particle size analysis by laser diffraction (Mastersizer® 2000, Malvern Instruments Ltd.) and scanning electron microscopy (Sirion 100T, FEI Company). For the results, see Table 2, FIG. 1 and FIG. 2.

TABLE 2
Particle sizes and analytically determined active compound content

| | | | | | Active |
|---|---|---|---|---|---|
| | D(v, 10) | D(v, 50) | D(v, 80) | D(v, 90) | compound |
| Sample | [μm] | [μm] | [μm] | [μm] | content [%] |
| 12-PMMA | 0.18 | 0.61 | 0.89 | 1.03 | 15.0 |

b) Active compound content
   The active compound content is determined by HPLC analysis. This gives an active compound content of 15.0% for the particles.
c) Release
   The formulation is applied to the coat of the dog, where the particles adhere and release the active compound. These special release conditions are difficult to reproduce in vitro. Accordingly, a release model was chosen which affords reliable reproducible results, but which only allows a comparison of different formulations as it cannot reflect the complex release parameters in vitro. A methanol/water mixture of a ratio of 70/30 was found to be suitable. This release medium does not dissolve the particles, and they don't swell.
   For the release experiment, the particles are dispersed in 5 ml of release medium and, at room temperature, continuously shaken over a period of 7 days (stage 7, horizontal sample arrangement; Multi Wrist® Shaker, Lab-Line Instruments).
   The release starts with a burst effect of ˜10%. Subsequently, the active compound is released in a steady manner. The logarithmic representation gives a straight line having a coefficient of determination of R²=0.9557. The release curve shows that about 45% of the active compound present are released after 7 days (168 h) (FIG. 3).
d) Glass transition temperature
   Using DSC analysis, it is possible to demonstrate how homogeneous the structure of the particles is. In the case of an inhomogeneity, a plurality of thermal reactions would be visible. If the particle components are of sufficient compatibility, only one endothermic reaction should be observed. In this case, there is a glass transition. Moreover, the emulsifier Eudragit® RS 100 (first curve, Tgₒₙₛₑₜ=41° C.) and the active compound (not shown, since Tg not measurable) have been found to be plasticizers, as they lower the glass transition of the active compound-loaded particles (fourth curve, Tgₒₙₛₑₜ=65° C.) compared to the placebo particles (third curve, Tgₒₙₛₑₜ=92° C.) and to the pure polymer (second curve, Tgₒₙₛₑₜ=105° C.) (FIG. 4).

The measurement was carried out using an open 40 μl aluminium crucible (DSC 822^{e}, STAR^{e} SW 9.20, Mettler Toledo GmbH). To this end, the sample is heated in temperature steps of 10 IC/min from 20° C. to 200° C. In the same manner, the sample is cooled from 200° C. to 20° C. and then reheated.

### Example 2

A further option for optimization or modification consists in the selection of the matrix polymer employed. A further polymer may be added to the PMMA used. Thus, the preparation procedure of Example 1 is employed, but polystyrene (MW=˜265 800 g/mol; PS 158, BASF) is added to the matrix polymer. In this manner, it is possible to prepare mixtures of 90/10, 80/20 or else 60/40 of PMMA and polystyrene (see Table 3). To demonstrate miscibility of the two polymers, placebo particles are prepared. One of these formulations is repeated with addition of the active compound flumethrin. The active compound can be incorporated without any problems.

TABLE 3
Feed materials

| | | | | Amount |
|---|---|---|---|---|
| | | | | d) 80/20 |
| | Amount | Amount | Amount | with active |
| Feed materials | a) 90/10 | b) 80/20 | c) 60/40 | compound |
| Demin. water | 80 ml | 80 ml | 80 ml | 80 ml |
| Dichloromethane | 20 ml | 20 ml | 20 ml | 20 ml |
| PMMA | 1.68 g | 1.49 g | 1.12 g | 1.49 g |
| Polystyrene (PS158; BASF) | 0.19 g | 0.37 g | 0.75 g | 0.37 g |
| Eudragit ® RS 100 | 0.33 g | 0.33 g | 0.33 g | 0.33 g |
| Flumethrin | — | — | — | 0.38 g |

The particles resulting from the formulations are examined for their size distribution and glass transition temperature. For comparison, the glass transition temperatures of the pure polymers are also measured (Table 4).

TABLE 4
Particle sizes and glass transition temperature

| | | | | | |
|---|---|---|---|---|---|
| | Tg | D(v, 10) | D(v, 50) | D(v, 80) | D(v, 90) |
| Sample | [° C.] | [μm] | [μm] | [μm] | [μm] |

| | | | | | |
|---|---|---|---|---|---|
| PMMA/PS | 93.35 | 0.49 | 0.75 | 0.98 | 1.11 |
| 90/10 | | | | | |
| PMMA/PS | 90.99 | 0.54 | 0.77 | 0.97 | 1.09 |
| 80/20 | | | | | |
| PMMA/PS | 89.88 | 0.45 | 0.82 | 1.19 | 1.41 |
| 60/40 | | | | | |
| PMMA/PS | 71.06 | 0.37 | 0.72 | 1.07 | 1.28 |
| 80/20 | | | | | |
| with flumethrin | | | | | |
| PS | 85.40 | | | | |
| PMMA | 102.91 | | | | |

FIG. 5 shows a scanning electron microscope picture of the placebo particles with the mixture PMMA/PS 60/40.

### Example 3

The preparation of the particles is carried out as described in Example 1, only the organic solvent dichloromethane is replaced by a different solvent. In this example, for dissolving the components of the particles, ethyl acetate is used. Data for the formulation with and without active compound (AC) are shown.

TABLE 5
Feed materials

| | Amount | | Amount | |
|---|---|---|---|---|
| Feed materials | a) without AC | | b) with AC | |
| Demin. water | 80 | ml | 80 | ml |
| Ethyl acetate | 20 | ml | 20 | ml |
| PMMA | 1.85 | g | 1.85 | g |
| Eudragit ® RS 100 | 0.33 | g | 0.33 | g |

| | | | |
|---|---|---|---|
| Flumethrin | — | 0.38 | g |

For the further course of the experiment, the same procedure is adopted; however, in order to evaporate the solvent, the emulsion has to be heated to 75° C. The particle size distribution is shown in Table 6.

TABLE 6
Particle size distribution

| | D(v, 10) | D(v, 50) | D(v, 80) | D(v, 90) |
|---|---|---|---|---|
| Formulation | [μm] | [μm] | [μm] | [μm] |
| a) without AC | 0.26 | 0.55 | 0.95 | 1.31 |
| b) with AC | 0.45 | 0.77 | 1.08 | 1.26 |

A scanning electron microscope picture is shown in FIG. 6.

### Example 4

The microparticles are prepared using the preparation procedure of Example 1. The composition is shown in Table 7. The matrix polymers used are polymethyl methacrylates of various molecular weights (Mw=2000 to 600 000 Da). Also, the active compound flumethrin is replaced by an arylpyrrolidine derivative N-[[4-[3-(3,5-dichlorophenyl)-3-(trifluoromethyl)-1-pyrrolidinyl]-2-(trifluoro-methyl)phenyl]methyl]propenamide (CAS No.: 1221692-86-9). This active compound, too, can be incorporated into the microparticles without any problems.

TABLE 7
Feed materials

| Feed materials | Amount |
|---|---|
| Demin. water | 160 ml |
| Dichloromethane | 40 ml |
| PMMA (Mw = 2000-600 000 Da) | 3.70 g |
| Eudragit ® RS 100 | 0.65 g |
| Arylpyrrolidine derivative | 0.77 g |

Table 8 shows the particle size distributions and glass transition temperatures obtained.

TABLE 8
Particle size distribution and glass transition temperature

| | | Active | | | | |
|---|---|---|---|---|---|---|
| | | compound | | | | |
| Formulation with | Tg | content | D(v, 10) | D(v, 50) | D(v, 80) | D(v, 90) |
| matrix polymer | [° C.] | [%] | [μm] | [μm] | [μm] | [μm] |
| PMMA Mw 2000 | 58 | 14.9 | 0.19 | 0.84 | 1.41 | 1.97 |
| PMMA Mw 12 000 | 79 | 14.6 | 0.31 | 0.73 | 1.28 | 1.71 |
| PMMA Mw 80 000 | 86 | 15.5 | 0.18 | 0.67 | 0.97 | 1.12 |
| PMMA Mw 600 000 | 92 | 13.0 | 1.09 | 2.23 | 3.38 | 4.08 |

The DSC analyses are shown in FIG. 7 (method as described in Example 1).

With increasing molecular weight, an increase in glass transition temperature is observed.

### Example 5

The use of plasticizers may also be utilized to modify the properties of the particles. Here, the preparation is carried out as described in Example 1. The plasticizer is co-dissolved in the organic phase. The composition of formulations having an increasing content of plasticizers is shown in the table below. In this case, the plasticizer is benzyl benzoate, which is also used as a solvent for parenteral injection formulations in veterinary medicine.

TABLE 9
Feed materials of formulations having different plasticizer
concentrations

| | Amount | | Amount | | Amount | |
|---|---|---|---|---|---|---|
| Feed materials | a) 10% | | b) 20% | | c) 30% | |
| Demin. water | 80 | ml | 80 | ml | 80 | ml |
| Dichloromethane | 20 | ml | 20 | ml | 20 | ml |
| PMMA | 1.85 | g | 1.85 | g | 1.85 | g |
| Eudragit ® RS 100 | 0.33 | g | 0.33 | g | 0.33 | g |
| Benzyl benzoate | 0.24 | g | 0.54 | g | 0.93 | g |

The plasticizer may be mixed into the formulation at various concentrations. In this manner, it is possible to vary the glass transition temperature. The glass transition temperatures resulting from the plasticizer concentration are shown in Table 10, as is the particle size distribution.

TABLE 10
Particle size distribution and glass transition temperatures

| Proportion of | Tg | D(v, 10) | D(v, 50) | D(v, 80) | D(v, 90) |
|---|---|---|---|---|---|
| plasticizer [%] | [° C.] | [μm] | [μm] | [μm] | [μm] |
| 10 | 69 | 1.01 | 1.51 | 1.94 | 2.18 |
| 20 | 46 | 1.00 | 1.50 | 1.92 | 2.17 |
| 30 | 26 | 0.96 | 1.44 | 1.85 | 2.08 |

The following substances are likewise suitable for use as plasticizer: tributyl acetylcitrate, triethyl citrate, Hexamoll® (BASF). These, too, reduce the glass transition temperature with increasing concentration.

### Example 6

In addition to the encapsulation of insecticides, it is also possible to encapsulate repellents such as the active compound icaridin. However, the solubility of the active compound in water has to be taken into account. Thus, the procedure of Example 1 is adopted, but in addition the aqueous phase is saturated with active compound. The composition is shown in the table below.

TABLE 11
Feed materials

| Feed materials | Amount | |
|---|---|---|
| Demin. water | 160 | ml |
| Dichloromethane | 40 | ml |
| PMMA | 3.70 | g |
| Gafquat ® 755N | 0.74 | g |
| Icaridin | 0.88 | g |
| Icaridin (to saturate the | 2 | g |
| aqueous phase) | | |

The particle components are dissolved in the organic phase. The aqueous phase is saturated with the active compound. The organic phase is dispersed in the aqueous phase using the Ultra Turrax® (9500 rpm, 2 min). The solvent is removed by heating (45° C.) and stirring with a magnetic stirrer, and the particle suspension is then washed with water, filtered off and dried. The particle size distribution is shown in Table 12.

TABLE 12
Particle size distribution

| | D(v, 10) | D(v, 50) | D(v, 80) | D(v, 90) |
|---|---|---|---|---|
| Sample | [μm] | [μm] | [μm] | [μm] |
| PMMA/icaridin | 0.85 | 1.31 | 1.72 | 1.95 |

The particles obtained are shown in FIG. 8

### Example 7

As a further repellent, it is possible to encapsulate DEET (N,N-diethyl-m-toluamide). The solubility of the active compound in water has to be taken into account to ensure successful encapsulation. The preparation is carried out as described in Example 6, and here, too, the aqueous phase is saturated with active compound. The particle size distribution is shown in Table 13.

TABLE 13
Particle size distribution

| | D(v, 10) | D(v, 50) | D(v, 80) | D(v, 90) |
|---|---|---|---|---|
| Sample | [μm] | [μm] | [μm] | [μm] |
| PMMA/DEET | 0.39 | 0.70 | 0.95 | 1.09 |

### Example 8

The ratio of organic to aqueous phase was varied and optimized in favour of the organic phase. Thus, with the same amount of PMMA based on the non-aqueous phase, it is possible to increase the amount of particles obtained. The preparation of the particles is carried out as described under Example 1. In addition to various placebo formulations, verum particles are also generated. The composition of the individual formulations is shown in Table 14.

TABLE 14
Feed materials

| | Formulation | | | | | | |
|---|---|---|---|---|---|---|---|
| Feed materials | 1 | 2 | 3 | 4 | 5 | 6 | 7 |
| Demin. water | 80 ml | 70 ml | 60 ml | 70 ml | 60 ml | 80 ml | 60 ml |
| Dichloromethane | 20 ml | 20 ml | 20 ml | 30 ml | 40 ml | 20 ml | 40 ml |
| PMMA | 1.86 g | 1.86 g | 1.86 g | 2.79 g | 3.72 g | 1.86 g | 3.72 g |
| Eudragit ® RS 100 | 0.37 g | 0.37 g | 0.37 g | 0.56 g | 0.74 g | 0.37 g | 0.74 g |
| flumethrin | — | — | — | — | — | 0.39 g | 0.79 g |

For the active compound-comprising formulations, the following size distributions were found for the particle size (Table 15).

TABLE 15
Particle size distribution

| | D(v, 10) | D(v, 50) | D(v, 80) | D(v, 90) |
|---|---|---|---|---|
| Formulation | [μm] | [μm] | [μm] | [μm] |
| 1 | 1.21 | 1.99 | 2.72 | 3.14 |
| 2 | 1.16 | 1.85 | 2.46 | 2.82 |
| 3 | 1.18 | 1.87 | 2.49 | 2.86 |
| 4 | 1.17 | 1.86 | 2.48 | 2.85 |
| 5 | 1.17 | 1.80 | 2.34 | 2.66 |
| 6 | 0.39 | 0.74 | 1.01 | 1.17 |
| 7 | 0.65 | 1.10 | 1.53 | 1.79 |

### Example 9

### Comparative Example

### Polyquaternium-11

The microparticles are prepared according to the preparation procedure of Example 6. Instead of the copolymer Eudragit® RS 100, the water-soluble cationic polymer polyquaternium-11 (Gafquat® 755N, ISP, Cas No.: 53633-54-8, quaternized copolymer of vinylpyrrolidone and dimethylaminoethyl methacrylate, cf. WO97/45012) is used.

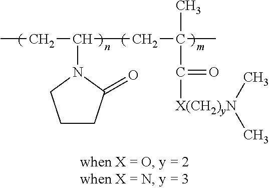

General structural formula for copolymers of the “Gafquat® 755N” type

The composition is shown in Table 16.

TABLE 16
Feed materials

| Feed materials | Amount | |
|---|---|---|
| Demin. water | 160 | ml |
| Dichloromethane | 40 | ml |
| PMMA | 3.70 | g |
| Gafquat ® 755N | 0.74 | g |
| Icaridin | 0.88 | g |
| Icaridin (to saturate the | 2 | g |
| aqueous phase) | | |

It is not possible to prepare a stable emulsion having a homogeneous particle size distribution. After evaporation of the solvent, the polymer forms an aggregate and hardly any separate microcapsules can be identified. A light-microscopic photo taken after the microfluidizer had been allowed to act on the emulsion is shown in FIG. 9, the resulting suspension is shown in FIG. 10.

In contrast to the water-insoluble Eudragit® RS 100, the water-soluble Gafquat® 755N is not suitable for preparing a stable suspension.

### Example 10

### Comparative Example

### Polyquaternium-28

The microparticles are prepared according to the preparation procedure of Example 6. Instead of the copolymer Eudragit® RS 100, the water-soluble cationic polymer polyquaternium-28 (Gafquat® HS-100, ISP, CAS No.: 131954-48-8, copolymer of vinylpyrrolidone and methacrylamidopropyl trimethylammonium chloride, cf. WO97/45012) is used.

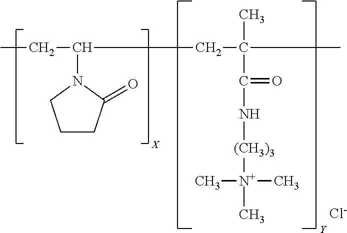

General structural formula for copolymers of the “Gafquat® HS-100” type

The composition is shown in Table 17.

TABLE 17
Feed materials

| Feed materials | Amount | |
|---|---|---|
| Demin. water | 160 | ml |
| Dichloromethane | 40 | ml |
| PMMA | 3.70 | g |
| Gafquat ® HS-100 | 0.74 | g |
| Icaridin | 0.88 | g |
| Icaridin (to saturate the | 2 | g |
| aqueous phase) | | |

It is not possible to prepare a stable emulsion having a homogeneous particle size distribution. After evaporation of the solvent, the polymer forms an aggregate and hardly any separate microcapsules can be identified. A light-microscopic photo taken after the microfluidizer had been allowed to act on the emulsion is shown in FIG. 11, the resulting suspension is shown in FIG. 12.

In contrast to the water-insoluble Eudragit® RS 100, the water-soluble Gafquat® HS-100 is not suitable for preparing a stable suspension.

### Example 11

### Comparative Example

### PMMA

Only PMMA is used, Eudragit is not employed.

The microparticles are prepared by the preparation procedure of Example 6.

However, the experiment is carried out without using the copolymer Eudragit® RS 100. The composition is shown in Table 18.

TABLE 18
Feed materials

| Feed materials | Amount | |
|---|---|---|
| Demin. water | 160 | ml |
| Dichloromethane | 40 | ml |
| PMMA | 3.70 | g |
| Icaridin | 0.88 | g |
| Icaridin (to saturate the | 2 | g |
| aqueous phase) | | |

It is not possible to prepare a stable emulsion, there is phase separation. A light-microscopic photo is shown in FIG. 13.

### Example 12

### Comparative Example

### Eudragit® RS 100

Only Eudragit® RS 100 is used as polymer phase, but no uncharged polymer PMMA. The microparticles are prepared by the procedure of Example 6. Instead of the polymer PMMA, only Eudragit® RS 100 is used. The composition is shown in Table 19.

TABLE 19
Feed materials

| Feed materials | Amount | |
|---|---|---|
| Demin. water | 160 | ml |
| Dichloromethane | 40 | ml |
| Eudragit ® RS100 | 4.0 | |
| Icaridin | 0.88 | g |
| Icaridin (to saturate the | 2 | g |
| aqueous phase) | | |

In this case, microparticles are formed; however, most of these are present in the dispersion as agglomerates which can no longer be re-dispersed, even after prolonged treatment with ultrasound. The particle size distribution was measured using a Mastersizer 3000 from Malvern. (Evaluation: Fraunhofer diffraction, refractive index of the microparticles 1.59; refractive index of the solvent 1.33, ultrasound treatment at 100%).

The particle size distribution is shown in Table 20.

TABLE 20
Particle size distribution

| | Ultra- | | | | |
|---|---|---|---|---|---|
| | sound | | | | |
| | treatment | D(v, 10) | D(v, 50) | D(v, 90) | D(v, 97) |
| Sample | [min] | [μm] | [μm] | [μm] | [μm] |
| Eudragit ® | 0 | 8.26 | 216 | 449 | 546 |
| RS 100/ | 6 | 1.22 | 8.93 | 25.4 | 34.0 |
| icaridin | 16 | 1.26 | 7.37 | 20.9 | 27.6 |

The particle size distribution of the dispersion without ultrasound treatment is shown in FIG. 14, FIG. 15 shows the particle size distribution of the dispersion after 16 min of treatment with ultrasound.

In the electron-microscopy image, after the dispersion has dried, it is no longer possible to identify any individual particles (FIG. 16).

Thus, active compound-comprising microparticle dispersions prepared exclusively with cationic film-forming polymer Eudragit® RS 100 cannot be used for the purposes of the invention for achieving the object at hand.

### Biological Example

The laboratory formulation (Example 1) is tested in an in vivo experiment. For this purpose, in each case three beagle dogs are available for the formulation and the control group. The microparticles are tested in a spray formulation comprising 66 mg of an encapsulated active compound in 30 ml of aqueous dispersion, which is sprayed onto the dog.

Fluorescent particles having the same composition as the verum particles, only with the active compound being replaced by a fluorescent dye (Uvitex® OB) are added to the experimental formulation. These fluorescent particles are inactive and serve only for a more rapid and easier visualization of the particles on the coat. Thus, with the aid of a fluorescent microscope it can be checked whether there are still particles on the coat.

The in vitro experiment carried out comprises nine beagle dogs, both female and male. The animals are 21-30 month old and weigh between 8.8 and 15.5 kg. Identification is by ear tattoo numbers. The dogs are without any clinical signs, healthy and used to the conditions under which they are kept during the experiment. If there are unexpected reactions to the experimental formulations, or if an animal becomes ill for any other reason, it is removed from the study. The dogs are kept in individual cages to avoid cross reactions. According to a fixed protocol, the dogs are populated with in each case 25 female and 25 male ticks of the genus Rhipicephalus sanguiineus (brown dog tick). To ensure better biting of the ticks, the dogs are anaesthetized for this purpose. The schedule of the study is shown in the table below.

TABLE 21
Schedule of the protocol in the animal experiment

| Week | Study day | Activity |
|---|---|---|
| 0 | −2 | physical examination for acceptance |
| | | weighing of the dogs |
| | −1 | infestation with ticks |
| | 0 | counting of ticks prior to the treatment |
| | | grouping of the dogs into treatment and control group |
| | | treatment |
| | | clin. examination (before, 2 and 4 h after treatment) |
| | 1 | clin. examination |
| | 2 | clin. examination |
| | | counting of ticks |
| 1 | 5 | infestation with ticks |
| | 7 | detailed general health monitoring |
| | | counting of ticks |
| 2 | 12 | infestation with ticks |
| | 14 | detailed general health monitoring |
| | | counting of ticks |
| 3 | 21 | infestation with ticks |
| | 23 | detailed general health monitoring |
| | | counting of ticks |
| 6 | 40 | infestation with ticks |
| | 42 | detailed general health monitoring |
| | | counting of ticks |
| 7 | 48 | infestation with ticks |
| | 50 | detailed general health monitoring |
| | | counting of ticks |
| 9 | 61 | infestation with ticks |
| | 63 | detailed general health monitoring |
| | | counting of ticks |

24 h prior to the treatment (study day=SD −1), the ticks are placed onto the dogs. Shortly before the start of the experiment (SD 0), the ticks which remain on the dogs are counted and the number is noted. The animals are grouped into treatment and control group depending on the number of ticks present on the dogs. At the start of the experiment, roughly the same number of ticks should be present in each group so that the starting conditions are as equal as possible. The dogs in the treatment group are sprayed evenly over the entire body with the experimental formulation. The control group is not treated. For safety reasons, 2 and 4 h after the application the dogs are examined for their state of health. Counting and removal of any live ticks still present on the dog is carried out 48 h after application of the formulation. The efficacy is checked on SD 2, 7, 23, 50, 63. On study days SD 2, 7, 14 and 42, hair samples (about 100 mg/sample) are removed from the dogs and examined analytically for the active compound flumethrin. To be able to make representative statements concerning the persistence of flumethrin particles on the dog, the coat samples are removed from different regions of the body. Individual hairs are examined microscopically. Under a fluorescent microscope, the placebo particles loaded with the fluorescent dye Uvitex® OB become visible. During the course of the experiment, the number of particles on the dog hair which adhere to the coat via electrostatic interaction falls. The fluorescent particles only have an indicator function. In this presentation, it is not possible to visualize the verum particles.

The microscopic pictures allow an illustrative presentation and rapid and simple checking of particles on the hair. In addition, the samples are worked up analytically. To this end, the coat samples are covered with 5 ml of acetonitrile. In this manner, the active compound flumethrin is extracted from the particles remaining on the coat overnight. Part of the acetonitrile is filtered and worked up by HPLC analysis. The results are shown in FIG. 17.

From the number of ticks on the dog, the geometrical mean and the efficiency are calculated as follows.

x̅_{geom}=ⁿ\sqrt{x₁·x₂·x₃ . . . ·xₙ} (Eq. 1)

$$Efficacy \% = \frac{{N}_{2} - {N}_{1}}{{N}_{2}} \cdot 100 \\ {N}_{1} \begin{matrix}Geometrical mean of the \\ number of ticks in the verum group\end{matrix} \\ {N}_{2} \begin{matrix}Geometrical mean of the \\ number of ticks in the control group\end{matrix} \qquad ( Eq . 2 )$$

The number of ticks counted on the respective study days on the individual dogs (dog ID=dog identification number; the last four numbers of the ear tattoo) is shown in Table 22.

TABLE 22
Results of the animal experiment

| | | Number of ticks | | | | | |
|---|---|---|---|---|---|---|---|
| Study Group | Dog ID | SD 0 | SD 2 | SD 7 | SD 23 | SD 50 | SD 63 |
| | 4641 | 20 | 4 | 1 | 2 | 1 | 7 |
| 12-PMMA | 6520 | 14 | 4 | 3 | 5 | 0 | 6 |
| 15.0% | 8919 | 19 | 6 | 0 | 2 | 1 | 17 |
| flumethrin | Geom. | | 4.6 | 1 | 2.8 | 0.6 | 9 |
| | mean | | | | | | |
| | Efficacy | | 71.2 | 89.8 | 72.3 | 93.2 | 24.3 |
| Control | 6231 | 10 | 10 | 2 | 4 | 9 | 6 |
| group | 4596 | 18 | 25 | 37 | 14 | 12 | 27 |
| untreated | 4586 | 20 | 16 | 10 | 17 | 6 | 10 |
| | Geom. | | 15.9 | 9.8 | 10.1 | 8.7 | 11.9 |
| | mean | | | | | | |

SD 0 is the day on which the dogs are sprayed with the particle formulation. On SD 2, the ticks remaining on the dog are counted. During the further course of the experiment, there are further infestations of the dogs with ticks, and the ticks are counted after 48 h. There is no additional spraying of the dogs with the experimental formulation. The relatively high variations in efficacy between the study days can be explained by the number of experimental animals used and the known high variance of biological experiments. In spite of this, Table 22 shows clearly that good activity against ticks can be noticed up to SD 50. Only between SD 50 and 63, is there a marked loss of activity. Thus, using the formulation of Example 1 according to the invention, it is possible to achieve a duration of action of 7 weeks against ticks.

### LIST OF FIGURES

FIG. 1 Particle size analysis in water, evaluation by Fraunhofer diffraction

FIG. 2 Scanning electron microscopic photo of the particles 12-PMMA

FIG. 3 Release of flumethrin from PMMA particles

FIG. 4 DSC analysis

FIG. 5 PMMA/PS 60/40

FIG. 6 Placebo particles prepared from ethyl acetate

FIG. 7 DSC analysis

FIG. 8 PMMA particles loaded with icaridin

FIG. 9 Emulsion with polyquaternium-11

FIG. 10 Suspension with polyquaternium-11

FIG. 11 Emulsion with polyquaternium-28

FIG. 12 Suspension with polyquaternium-28

FIG. 13 Unstable emulsion with PMMA (coalescing droplets/phase separation)

FIG. 14 Particle size distribution of the dispersion after 0 min of ultrasound treatment

FIG. 15 Particle size distribution of the dispersion after 16 min of ultrasound treatment

FIG. 16 SEM picture of the film-coated Eudragit® RS 100 particles

FIG. 17 Changes of the flumethrin content on the coat during the course of the experiment

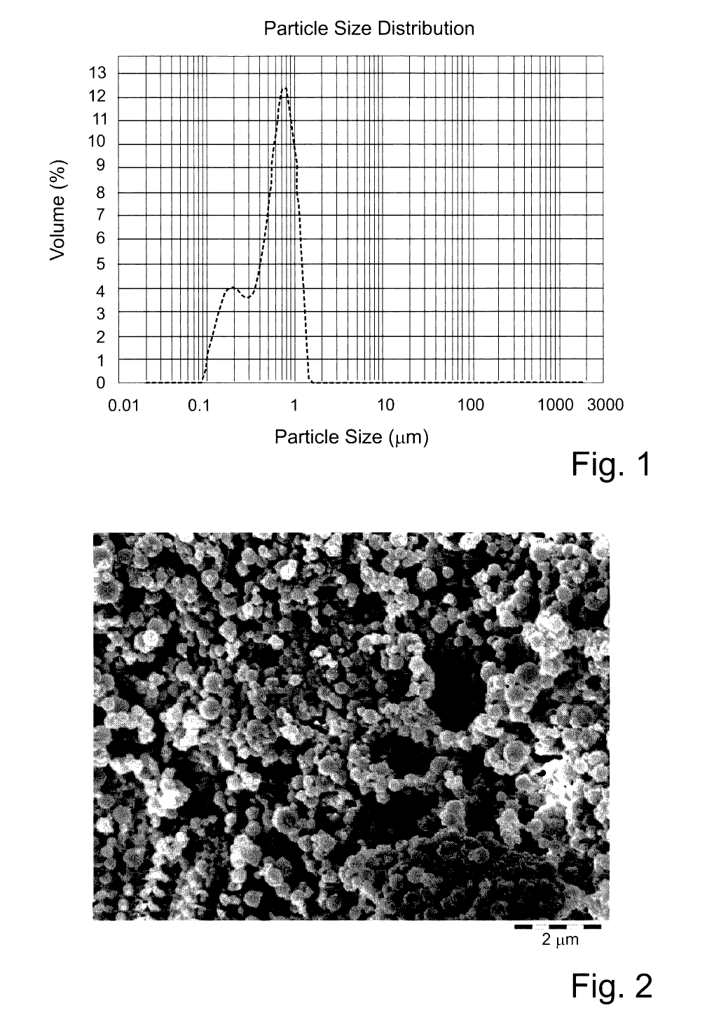

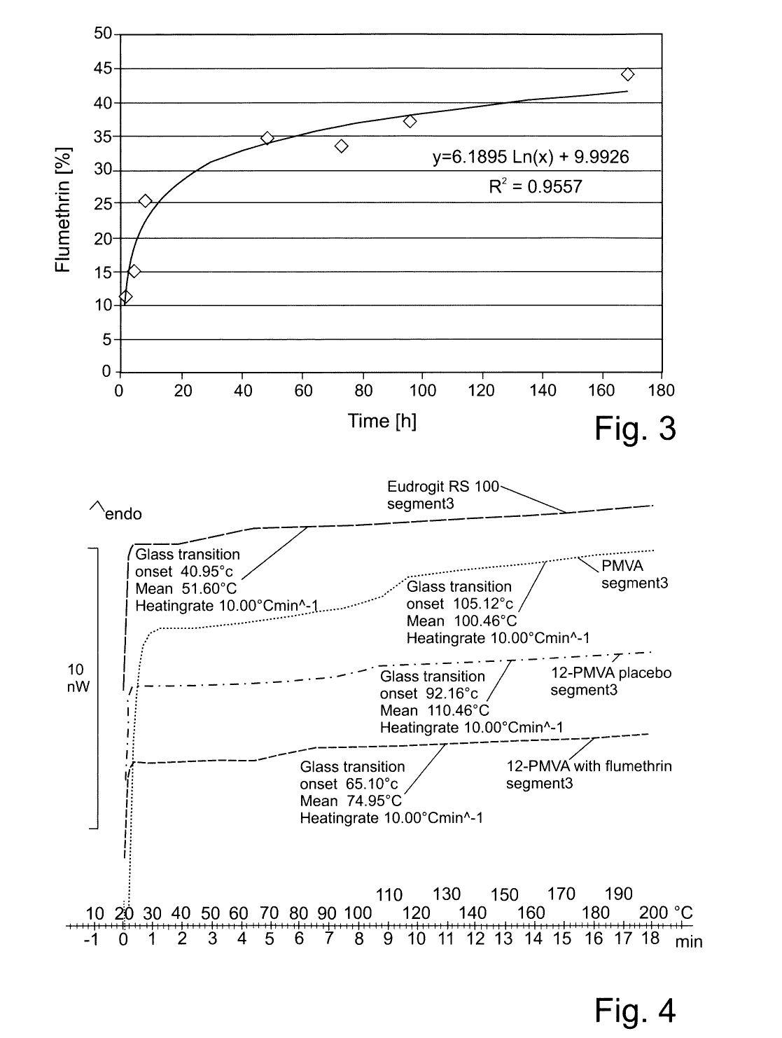

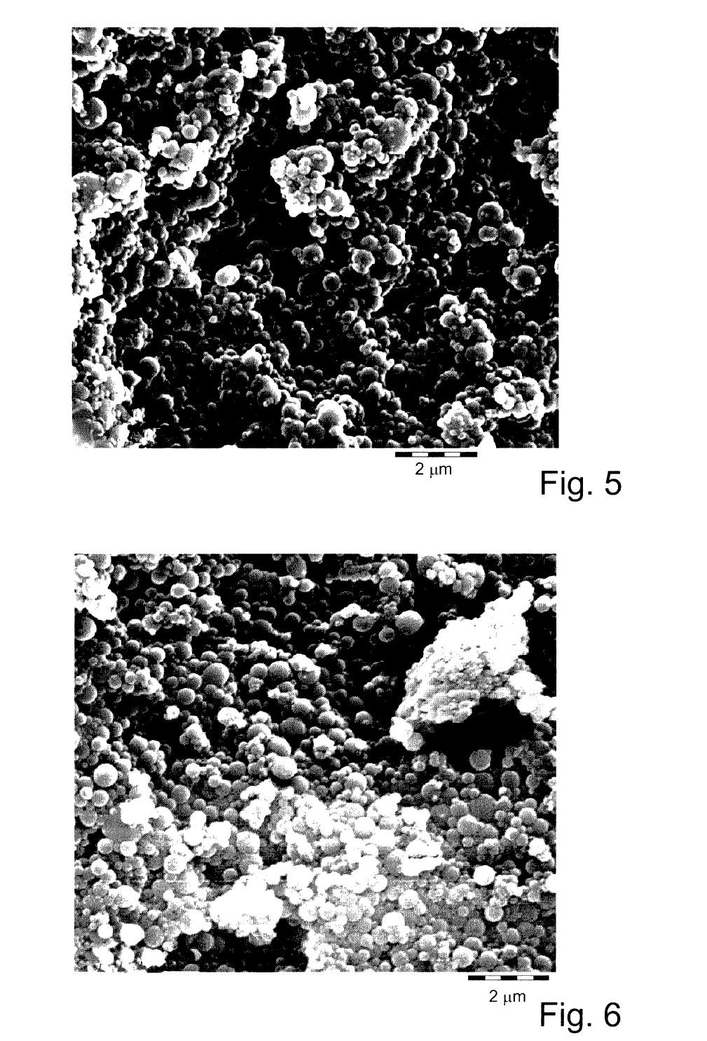

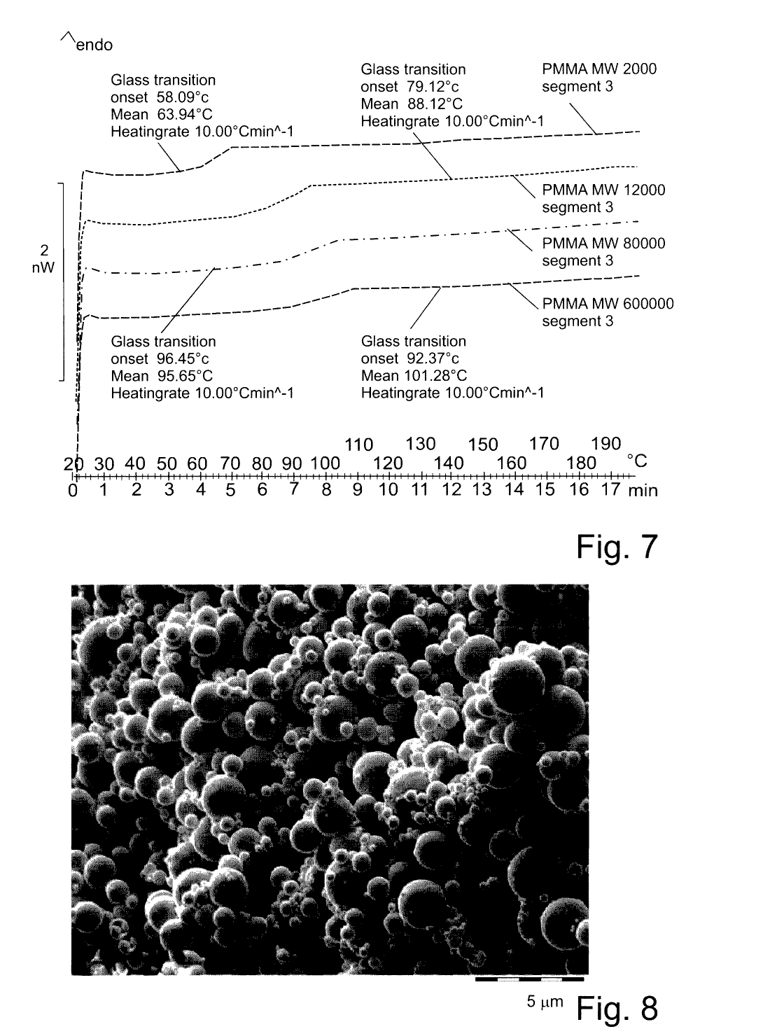

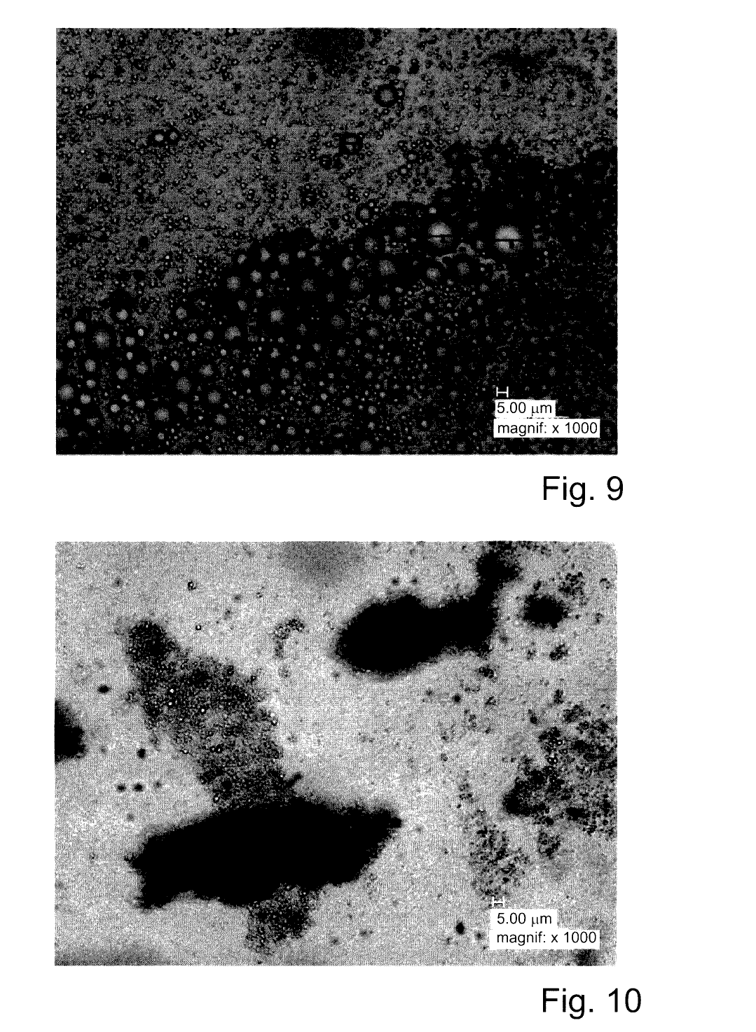

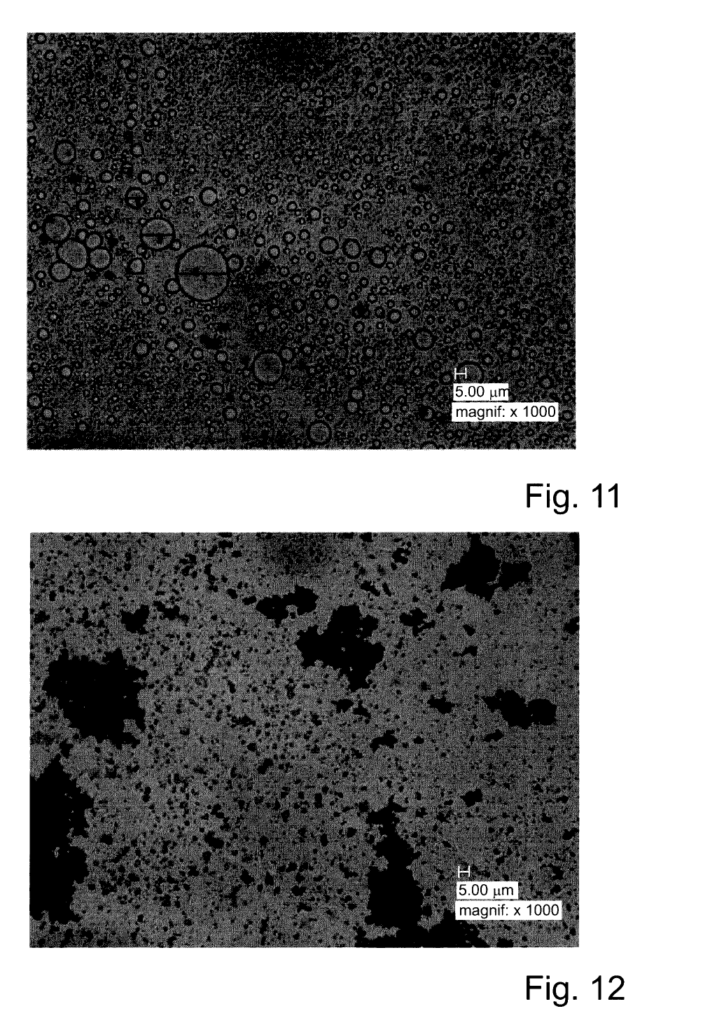

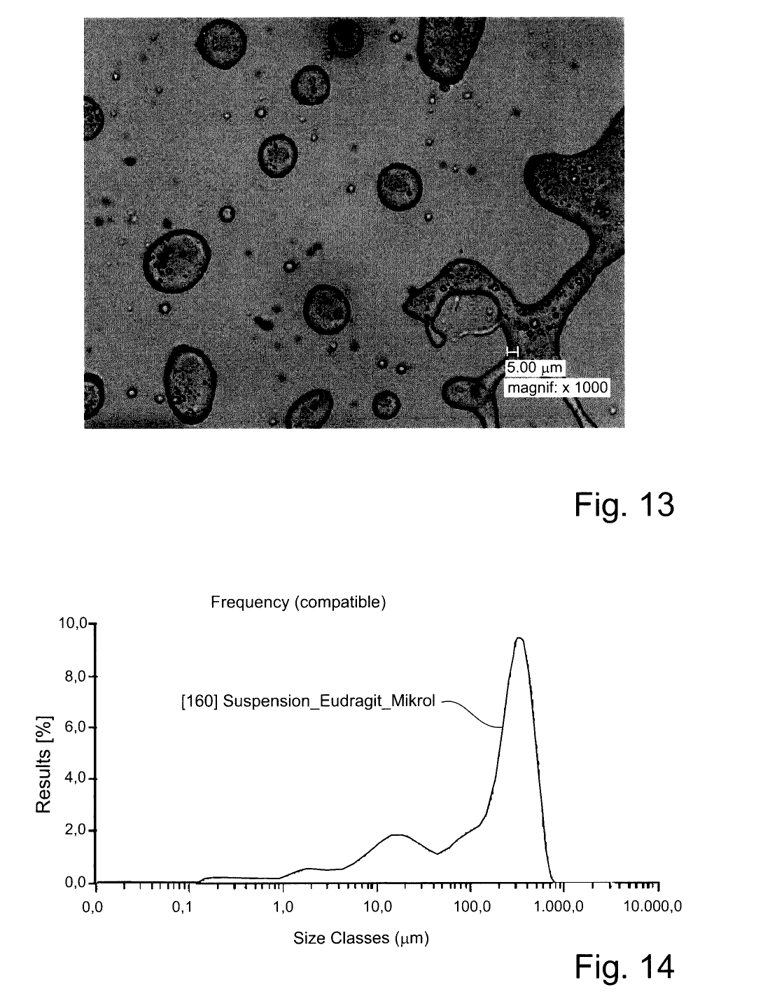

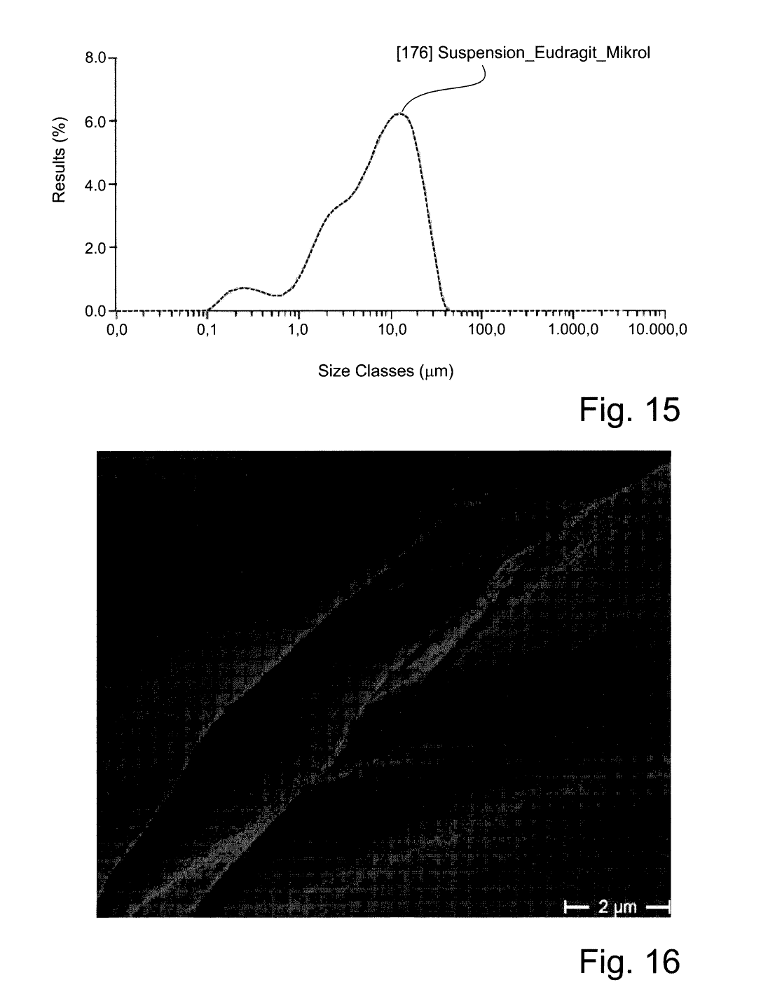

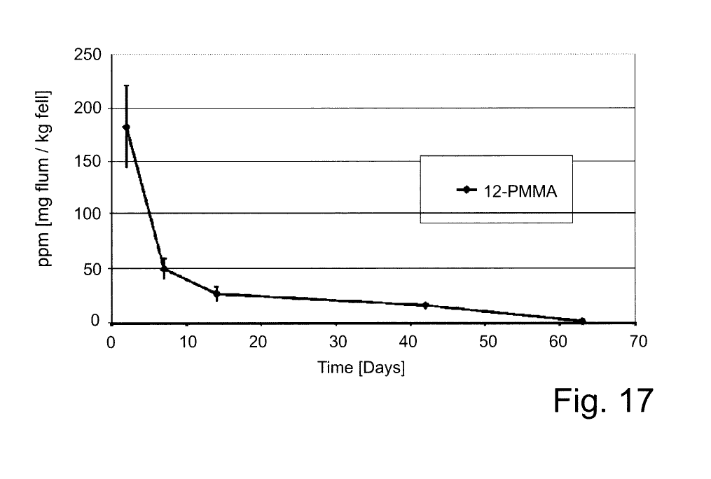

1. Particles having a particle size d(v,90) of at most 10 μm comprising
a) an uncharged polyacrylate and
b) a cationic polyacrylate which carries positively charged functional groups, where the particles
c) comprise one or more active compounds and
d) may optionally comprise further polymers, auxiliaries or additives.

2. Particles according to claim 1 having a particle size d(v,90) of 0.1-3 μm.

3. Particles according to claim 1 in which the cationic polyacrylate b) is a quaternized dialkylaminoalkyl methacrylate copolymer.

4. Particles according to claim 3 in which the cationic polyacrylate b) is a copolymer of (methyl, ethyl) acrylates, (methyl, ethyl) methacrylates and monochloromethane-quaternized dimethylaminoethyl esters of methacrylic acid.

5. Particles according to claim 1 in which the uncharged polyacrylate a) is poly(methyl methacrylate).

6. Particles according to claim 1 in which the mixing ratio of the uncharged polyacrylate a) to the cationic polyacrylate b) is from 5:95 (w/w) to 95:5 (w/w).

7. Particles according to claim 1 comprising, based on the mass of the particles, 0.1-50% by weight of active compound.

8. Particles according to claim 1 where the uncharged polyacrylate has a weight average molecular weight of from 1000 g/mol up to 1 000 000 g/mol.

9. Particles according to claim 1 comprising 0.1-50% by weight based on the total mass of the particles of one or more further polymers, preferably polystyrene.

10. Particles according to claim 1 comprising one or more plasticizers, surfactants, cosolvents, their sum, based on the total mass of the microparticles, being 0.1-40% by weight.

11. Particles according to claim 1 comprising, as active compound, flumethrin.

12. Particles according to claim 1 comprising, as active compound, a repellent, preferably icaridin or N,N-diethyl-m-toluamide.

13. Process for preparing the particles according to claim 1, comprising the following steps:
(i) preparing a solution of components a) to d) in a solvent or solvent mixture (1) poorly miscible with water, if at all,
(ii) dispersing the solution (i) in an aqueous phase optionally comprising additives and solvent or solvent mixture (1) to saturation, to obtain a fine, stable emulsion,
(iii) removing the solvent or solvent mixture (1) from the emulsion droplets by
I) evaporation (solvent evaporation process), to obtain an aqueous suspension, or
II) spray drying, to obtain a dry powder.

14. (canceled)

15. (canceled)

16. Particles according to claim 6 in which the mixing ratio of the uncharged polyacrylate a) to the cationic polyacrylate b) is from 70:30 (w/w) to 95:5 (w/w).

17. Particles according to claim 6 in which the mixing ratio of the uncharged polyacrylate a) to the cationic polyacrylate b) is from 80:20 (w/w) to 90:10 (w/w).

18. Particles according to claim 7 comprising, based on the mass of the particles, 1-20% by weight of active compound.

19. Particles according to claim 7 comprising, based on the mass of the particles, 5-15% by weight of active compound.

20. Particles according to claim 8 where the uncharged polyacrylate has a weight average molecular weight of from 20 000 to 600 000 g/mol.

21. Particles according to claim 8 where the uncharged polyacrylate has a weight average molecular weight of from 50 000-150 000 g/mol.

22. Particles according to claim 12, wherein the repellent is icaridin or N,N-diethyl-m-toluamide.
